(19) United States
(12) Patent Application Publication
(10) Pub. No.: US 2007/0052142 A1
(43) Pub. Date: Mar. 8, 2007

(54) Vibration damping device

(75) Inventor: Mutsumi Muraoka, Aichi-gun (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/514,209

(22) Filed: Sep. 1, 2006

(30) Foreign Application Priority Data
Sep. 5, 2005 (JP) 2005-256801
Nov. 30, 2005 (JP) 2005-346961
Jul. 6, 2006 (JP) 2006-186268

(51) Int. Cl. F16F 9/00

(52) U.S. Cl. 267/140.11

(57) ABSTRACT

A vibration damping device including: an elastic body of frustoconical shape; a first mounting member superposed against a small diameter end face of the elastic body; a second mounting member affixed to an outer circumferential face of a large-diameter end portion of the elastic body; and a rebound stopper mechanism for cushion-wise limitation of relative displacement of the first and second mounting members in a direction of moving apart. At least one of superposed faces of the first mounting member and the rubber elastic body is provided with a seal lip at an outside peripheral portion thereof so as to project outward therefrom and extend over an entire circumference thereof.

The disclosure of Japanese Patent Applications No. 2005-256801 filed on Sep. 5, 2005, No. 2005-346961 filed on Nov. 30, 2005, and No. 2006-186268 filed on Jul. 6, 2006, each including the specification, drawings and abstract is incorporated herein by reference in its entirety.

### BACKGROUND OF THE INVENTION

1. Field of the Invention

The present invention relates to a vibration damping device intended for installation between components to be linked in a vibration damping manner, and more particular to a vibration damping device have a first mounting member disposed separably in the axial direction from a main rubber elastic body, and furnished with a stopper mechanism for limiting relative displacement of the first mounting member and a second mounting member when excessive load is input.

2. Description of the Related Art

Vibration damping devices has been used for installation between two components to be linked and supported in a vibration damping fashion, in order to link and support the two members in the intended anti-vibrating state. In one type of these devices, a first mounting member and a second mounting member are elastically linked by a main rubber elastic body. U.S. Pat. No. 5,775,666 discloses one example of such device.

This kind of vibration damping device is typically furnished with a rebound stopper mechanism for the purpose of limiting relative displacement of the first mounting member and the second mounting member in the direction of moving apart (the rebound direction), mainly in order to suppress excessive deformation of the main rubber elastic body. However, even where such a rebound stopper mechanism is provided, depending on the magnitude of the input load, it is difficult in some instances to sufficiently limit relative displacement of the first mounting member and the second mounting member. As a result, it becomes difficult to suppress excessive deformation of the main rubber elastic body, creating the problem of a drop in durability.

To address this problem, a vibration damping device of novel structure have been proposed. As taught for example in U.S. Publication Nos. US2004/0262830 A1 and US2004/0262831 A1, the vibration damping device employs a structure wherein the second mounting member is affixed to the outside peripheral wall at the large-diameter end of a main rubber elastic body of frustoconical shape, while the first mounting member is superposed against the small-diameter end face of the main rubber elastic body, whereby the first mounting member is able to move away in the axial direction from the main rubber elastic body. By means of this design, when rebound load is input, the first mounting member and the main rubber elastic body experience relative moving apart, thereby reducing tensile stress in the main rubber elastic body and improving the durability of the main rubber elastic body.

In the vibration damping device of the construction described above, however, there is a risk that water, oil, or other foreign matter may infiltrate between the juxtaposed faces of the first mounting member and the main rubber elastic body, creating as a result the problem of noise occurring during vibration input.

### SUMMARY OF THE INVENTION

It is therefore one object of this invention to provide a vibration damping device of novel construction, able to prevent water, oil, or other foreign matter from infiltrating between the superposed faces of the first mounting member and the main rubber elastic body, thereby effectively reducing noise during vibration input.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a vibration damping device for installation between two components to be linked in a vibration damping manner, comprising: a main rubber elastic body of frustoconical shape; a first mounting member adapted to be fastened to one of the two components and being of independent structure, while being superposed against a small diameter end face of the rubber elastic body; a second mounting member adapted to be fastened to an other of the two components, and being affixed to an outer circumferential face of a large-diameter end portion of the main rubber elastic body; and a rebound stopper mechanism for cushion-wise limitation of the level of relative displacement of the first mounting member and the second mounting member in a direction of moving apart, wherein at least one of superposed faces of the first mounting member and the rubber elastic body is provided with a seal lip at an outside peripheral portion thereof so as to project outward therefrom and extend over an entire circumference thereof.

In the vibration damping device constructed in accordance with the present mode, the first mounting member is constituted as a separate component independent from the main rubber elastic body, with the first mounting member able to selectively assume a state of abutment against the main rubber elastic body or a state of separation therefrom. In the installed state, typically, a static initial load, e.g. the distributed support load of a power unit in an automotive engine mount, will be exerted across the first mounting member and the second mounting member, whereby the first mounting member and the main rubber elastic body become superposed in abutment against each other. In this installed state, the seal lip is interposed in a state of elastic deformation in intimate contact with the outside peripheral portions of the superposed faces of the first mounting member and the main rubber elastic body. The superposed faces of the first mounting member and the main rubber elastic body are sealed thereby, preventing foreign matter such as water or oil from infiltrating therein. Consequently, it is possible to effectively prevent the occurrence of noise which can become a problem during vibration input, caused by the infiltration of water or the like between the juxtaposed faces.

In particular, the seal lip is positioned only at the outside peripheral portions of the juxtaposed faces of the first mounting member and the main rubber elastic body so that it projects from one side toward the other side of these members. This makes it possible to reduce or avoid difficulty in attaining desired spring properties in the vibration damping device, that might otherwise result from interposing the seal lip between the first mounting member and the main rubber elastic body.

In preferred practice, this seal lip will be formed by a cushioning rubber layer projecting out from the outside peripheral face of the first mounting member and formed covering it. As taught in a fourth mode to be described later, the seal lip will project from the first mounting member side towards the main rubber elastic body side, in the outside peripheral portion of the first mounting member away to the outer peripheral side from the face thereof directly facing the main rubber elastic body. The seal lip of such construction will provide sufficient pliability despite its small projecting height, and adverse effects on the main rubber elastic body will be more advantageously avoided, as well as being able to achieve even better sealing function. Additionally, difficulty in the required characteristics of the seal lip being attained due to the effects of the spring properties of the vibration damping device will also be reduced or avoided.

A second mode of the invention provides a vibration damping device according to the first mode, wherein at least one of the superposed faces of the first mounting member and the main rubber elastic body is provided with grain shaped elastic projections on an inner circumferential side of the seal lip.

This arrangement makes it possible to reduce the area of the superposed faces of the first mounting member and the main rubber elastic body small, and to provide cushioning action based on elasticity of the elastic projections during superposition, thereby reducing more advantageously noise when the first mounting member and the main rubber elastic body are superposed. Additionally, even if some water or the like should happen to infiltrate between the superposed faces, the contact area of the water with the juxtaposed faces is small due to the presence of the elastic projections, thus suppressing noise more effectively.

A third mode of the invention provides a vibration damping device according to the first or second mode, wherein the seal lip has a cross sectional shape inclined outside or inside over an entire circumference thereof.

In the present mode, the direction of elastic deformation of the seal lip is kept constant towards radially inside or outside so that the seal lip deforms in a consistent manner. Thus, the sealing ability and durability of the seal lip may be further improved. By determining the direction of deformation of the seal lip in this way, variability in the spring properties of the vibration damping device in association with deformation of the lip can be avoided, thereby more consistently affording the desired spring properties.

A fourth mode of the invention provides a vibration damping device according to any of the first to third modes, wherein the seal lip is disposed at a location diametrically outside of a peripheral edge of an end face of the first mounting member superposed against the main rubber elastic body.

This arrangement according to this mode makes it possible to avoid variability in spring properties of the vibration damping device caused by the presence of the seal lip between the superposed faces of the first mounting member and the main rubber elastic body. Also, stress concentration in the seal lip can be reduced when the first mounting member and the main rubber elastic body come into abutment or move apart, whereby durability of the seal lip can be improved. Further, the seal lip can be imparted with softer spring properties, providing further improvement in its sealing ability.

A fifth mode of the invention provides a vibration damping device according to any one of the first to fourth modes, wherein at least one of the superposed faces of the first mounting member and the main rubber elastic body is furnished with an air venting groove opening onto the superposed face and exposed to an outer periphery of the superposed face.

In the present mode, air present between the superposed faces can escape through the air venting groove when the first mounting member and the main rubber elastic body are superposed, so that noise caused by a pocket of air between the superposed faces can be advantageously suppressed.

A sixth mode of the invention provides a vibration damping device according to any one of the first to fifth modes, wherein both of the superposed faces of the first mounting member and the main rubber elastic body have circular shape, and one of the superposed faces is larger in diameter than an other of the superposed faces, while the seal lip is formed on an outside peripheral portion of the superposed face having a smaller-diameter.

The arrangement according to this mode assures sufficient size of the portion against which the seal lip is superposed, so that the seal lip deforms in a consistent manner. Accordingly, sealing ability of the seal lip may be more advantageously achieved. Accordingly, the design may be favorably employed in vibration damping devices wherein the first mounting member and the main rubber elastic body sometimes become superposed in a state of being mispositioned in the axis-perpendicular direction, due to vibration input in erratic directions or to some idiosyncratic vibration of a member being damped.

A seventh mode of the invention provides a vibration damping device according to any one of the first to sixth modes, wherein said seal lip is formed projecting downward only on the superposed face positioned vertically upward in a installed state.

In the present mode, noise caused by water or the like infiltrating between the superposed faces of the first mounting member and the main rubber elastic body can be more advantageously suppressed. If the seal lip were disposed on the outside peripheral portion of the superposed face on the side positioned upward in the vertical direction when the device being installed between the members to be connected in a vibration damping manner, it is conceivable that the seal lip could function like a dam for water and so on infiltrating between the superposed faces, resulting in a tendency for the water etc. to pool between the superposed faces. However, this problem of pooling is eliminated by employing the arrangement of the present mode.

An eighth mode of the invention provides a vibration damping device according to any one of the first to seventh modes, wherein the first mounting member includes an abutting portion spreading out in an axis-perpendicular direction at a face thereof facing the main rubber elastic body; the main rubber elastic body includes a reinforcing member spreading out in the axis-perpendicular direction on the small-diameter end thereof facing the first mounting member; the second mounting member is fixedly furnished with a rebound stopper member having a rebound stopper projecting towards the first mounting member and situated facing the abutting portion of the first mounting member while spreading outwardly with respect to the abutting portion in an axis-perpendicular direction; the first mounting member further includes a rebound cushion rubber fixed thereto, the rebound cushion rubber projecting from the abutting portion towards the rebound stopper, said abutting portion coming into abutment against said rebound stopper via said rebound cushion rubber, thereby constituting said rebound stopper mechanism; a face of the abutting portion facing the main rubber elastic body has a covering rubber layer formed by said rebound cushion rubber; the abutting portion of said first mounting member and said reinforcing member of the main rubber elastic body are superposed against each other via the covering rubber layer; and the seal lip is integrally formed on the covering rubber layer.

In the present mode, by means of superposing the first mounting member and the main rubber elastic body via the abutting portion and the reinforcing member, the shape of the superposed areas is stabilized. Consequently, the seal lip will deform in a consistent manner, providing further improvement in its sealing ability. The provision of a reinforcing member is effective in terms of improving durability of the main rubber elastic body and the rebound cushion rubber.

A ninth mode of the invention provides a vibration damping device according to the eighth mode, further comprising a rebound stopper mechanism wherein at least one of opposed faces of the reinforcing portion and the abutting portion of the first mounting member includes a recess in a center portion thereof, and an other one of opposed faces includes a bound cushion rubber projecting therefrom toward the recess in a center portion thereof so as to be housed within the recess so that the first mounting member and the reinforcing portion come into cushioned abutment at the center portions thereof via the bound cushion rubber before coming into abutment at outside peripheral portions thereof via the covering rubber layers.

This arrangement according to the present mode can avoid or minimize concussive superposition of the first mounting member and the main rubber elastic body during vibration input, thereby affording improved durability, as well as more advantageously reducing noise occurring with superposition.

A tenth mode of the invention provides a vibration damping device according to the eighth or ninth mode, wherein the rebound cushion rubber has a projecting height varied in a circumferential direction in order to provide a high projecting portion and a low projecting portion having smaller projecting height than the high projecting portion, in alternating fashion in the circumferential direction.

According to this mode, there are provided steps on the rebound cushion rubber along the circumferential direction, making it possible to reduce or avoid airtight contact between the rebound cushion rubber and the rebound stopper when these come into abutment with one another. As a result, the abutting force of the cushion rubber and the stopper is dispersed, endurance is improved, and contact noise is advantageously reduced.

In particular, when the rebound cushion rubber and the rebound stopper come into abutment, a gap of prescribed size readily forms between the low projecting portion and the stopper, permitting air to flow through the gap. This prevents a condition of suction contact or the like which could result from airtight contact of the entire abutting face of the cushion rubber with the stopper. Consequently, noise occurring when the cushion rubber and the stopper under suction contact are separated can be effectively suppressed as well.

An eleventh mode of the invention provides a vibration damping device according to the tenth mode, wherein the rebound cushion rubber is furnished with a recessed groove opening onto a projecting distal end thereof and extending in a diametrical direction.

In the present mode, when the rebound cushion rubber and the rebound stopper come into abutment, air present between the abutting faces is allowed to flow through the recessed groove. As a result, suction contact of the cushion rubber and the stopper is more reliably prevented, and noise occurring when the cushion rubber and the stopper under suction contact are separated can be more advantageously suppressed.

In particular, in the present mode, since the flow of air is assured by means of furnishing such a recessed groove, it is not necessary for there to be large height differential between the high projecting portion and the low projecting portion. Consequently, by minimizing this height differential, during abutment of the rebound cushion rubber against the rebound stopper, a smooth transition from contact of the high projecting portion against the stopper to contact of the low projecting portion against the stopper can be produced, making it possible to consistently achieve linear spring properties.

An twelfth mode of the invention provides a vibration damping device according to the tenth or eleventh mode, wherein the recessed groove is formed at both circumferential edges of said low projecting portion of the rebound cushion rubber.

In the present mode, the high projecting portion and the low projecting portion connect with one another via a recessed groove formed at both circumferential edges of the low projecting portion, while the connecting portions between the high projecting portion and the low projecting portion are particularly susceptible to stress concentrations resulting from the height differential in the rebound cushion rubber. Thus, stress concentrations can be reduced by means of the elastic deformation behavior of the rubber in the portions furnished with the recessed groove, whereby improved durability may be achieved more advantageously.

A thirteenth mode of the invention provides a vibration damping device according to the tenth mode, wherein the abutting portion of the first mounting member is of circular disk shape; wherein the abutting portion of the first mounting member is of circular disk shape; the rebound stopper member is furnished with a tubular projecting portion that extends in a round tubular shape in the axial direction from said second mounting member so as to cover said main rubber elastic body and said abutting portion from an outer peripheral side, with said rebound stopper being formed extending diametrically inward from a projecting distal end of the tubular projecting portion; the basal end portion of said rebound cushion rubber attached to said abutting portion is of round annular shape viewed in the axial direction, while the distal end portion of the rebound cushion rubber is of elliptical annular shape viewed in the axial direction; the distal end portion of said rebound cushion rubber, in areas situated in opposition across the major axis direction thereof, is disposed in abutment against said contact portion member and said tubular projecting portion of said rebound stopper, whereas in areas situated in opposition across the minor axis direction thereof is spaced apart in the diametrical direction from said tubular projecting portion of said rebound stopper so as to be disposed in abutment against said abutting portion only; and the high projecting portions are formed at respective areas situated in opposition across the major axis direction of said rebound cushion rubber, while the low projecting portions are formed at respective areas situated in opposition across the minor axis direction of said rebound cushion rubber.

In the present mode, areas of the rebound cushion rubber in the major axis direction thereof are disposed in abutment against the abutting portion and the tubular projecting portion in the axial direction and the axis-perpendicular direction, thereby providing relative hard spring properties in the major axis direction. On the other hand, areas of the rebound cushion rubber in the minor axis direction thereof are disposed in abutment with the abutting portion only, thereby providing relative soft spring properties in the minor axis direction. Additionally, by forming high projecting portions in areas situated in opposition across the major axis direction so that these abut the abutting portion relatively strongly, while forming low projecting portions in areas situated in opposition across the minor axis direction so that these abut the abutting portion relatively weakly, high spring in the major axis direction and low spring in the minor axis direction can be achieved more advantageously, and the axis-perpendicular direction spring ratio in the vibration damping device can be established advantageously. Consequently, by establishing the major axis direction and the minor axis direction with reference to spring properties in the required directions when installed on members to be vibration damped, it is possible to achieve an even better level of vibration damping capability, while favorably preventing noise occurring in association with contact between the stopper and the cushion rubber.

A fourteenth mode of the invention provides a vibration damping device according to any one of the eighth through twelfth modes, wherein the rebound stopper member includes a tubular projecting portion extending in an axial direction from said second mounting member with a round tubular shape and disposed so as to cover from an outer peripheral side of the main rubber elastic body and the abutting portion, and an outside peripheral face of an distal end of the rebound cushion rubber is positioned spaced apart inwardly in the axis-perpendicular direction from an inside peripheral face of the tubular projecting portion around an entire circumference.

In the present mode, the rebound cushion rubber is disposed so as to be spaced apart in the axis-perpendicular direction from the tubular projecting portion around the entire circumference in the absence of load input, whereby durability and load bearing properties of the rebound cushion rubber can be more advantageously assured, as compared to case where the rebound cushion rubber pushes against the tubular projecting portion in the axis-perpendicular direction.

A fifteenth mode of the invention provides a vibration damping device according to any one of the eighth through twelfth modes, wherein the abutting portion of the first mounting member is of circular disk shape; and the abutting portion includes a thick portion projecting towards the rebound stopper in an axial direction formed on at least a portion of a circumference of the abutting portion so that a distance separating the abutting portion and the rebound stopper in the axial direction is smaller in localized fashion at the site where said thick portion is formed.

In the present mode, by reducing the distance separating the abutting portion and the rebound stopper in the axial direction, elastic deformation of the rebound cushion rubber can be limited, thus avoiding rupture or other damage to the rebound cushion rubber caused by excessive elastic deformation. With this arrangement, durability of the rebound cushion rubber can be improved.

As will be apparent from the preceding description, the vibration damping device constructed in accordance with the present invention ensures sealing advantageously effected between the superposed faces first mounting member and the main rubber elastic body, on the basis of elastic deformation of a seal lip provided therebetween. In particular, by disposing this seal lip at the outside peripheral portion of a superposed face, it is possible to hold any effects on the spring properties of the vibration damping device resulting from superposition of the first mounting member and the main rubber elastic body via the seal lip to a level such that no problems will be encountered thereby. As a result, it is possible to effectively reduce the occurrence of noise caused by infiltration of water or the like between the superposed faces, while ensuring the desired spring properties.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a vibration damping device in the form of an automotive engine mount of construction according to a first embodiment of the invention, taken along line 1-1 of FIG. 2;

FIG. 2 is a cross sectional view taken along line 2-2 of FIG. 1;

FIG. 3 is a top plane view of a second integral vulcanization molded component of the engine mount of FIG. 1;

FIG. 4 is a vertical cross sectional view of a first integral vulcanization molded component of the engine mount of FIG. 1, taken along line 4-4 of FIG. 5;

FIG. 5 is a bottom plane view of the first integral vulcanization molded component of FIG. 4;

FIG. 6 is a fragmentary enlarged view in vertical cross section of the principle part of the first integral vulcanization molded component of FIG. 4, taken along line 6-6 of FIG. 5;

FIG. 7 is a fragmentary enlarged view in vertical cross section of the principle part of the engine mount of FIG. 1;

FIG. 8 is a fragmentary enlarged view in vertical cross section of the principle part in another arrangement of the engine mount of FIG. 1;

FIG. 9 is a vertical cross sectional view of a first integral vulcanization molded component of an engine mount of construction according to a second embodiment of the invention, taken along line 9-9 of FIG. 10;

FIG. 10 is a top plane view of the first integral vulcanization molded component of FIG. 9;

FIG. 11 is an enlarged view as seen from the direction indicated by allows 11-11 of FIG. 10;

FIG. 12 is an elevational view in axial or vertical cross section of an automotive engine mount of construction according to a third embodiment of the invention, taken along line 12-12 of FIG. 14;

FIG. 13 is a top plane view of the first mounting member of the engine mount of FIG. 12;

FIG. 14 is a cross sectional view taken along line 14-14 of FIG. 12;

FIG. 15 is a vertical cross sectional view of the first integral vulcanization molded component of the engine mount of FIG. 12, taken along line 15-15 of FIG. 16;

FIG. 16 is a bottom plane view of the first integral vulcanization molded component of FIG. 15;

FIG. 17 is a view for explaining a condition for abutment between the abutting face and the abutted face in the engine mount of FIG. 12; and

FIG. 18 is a view for explaining a condition for abutment by a given amount of rotation between the abutting face and the abutted face in the engine mount of FIG. 12.

### DETAILED DESCRIPTION OF PREFERRED EMBODIMENTS

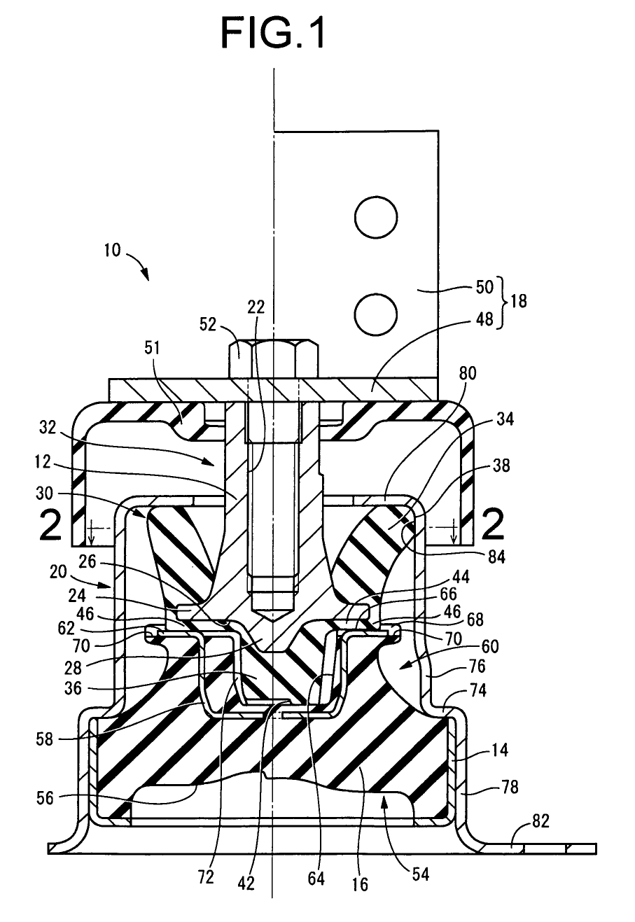

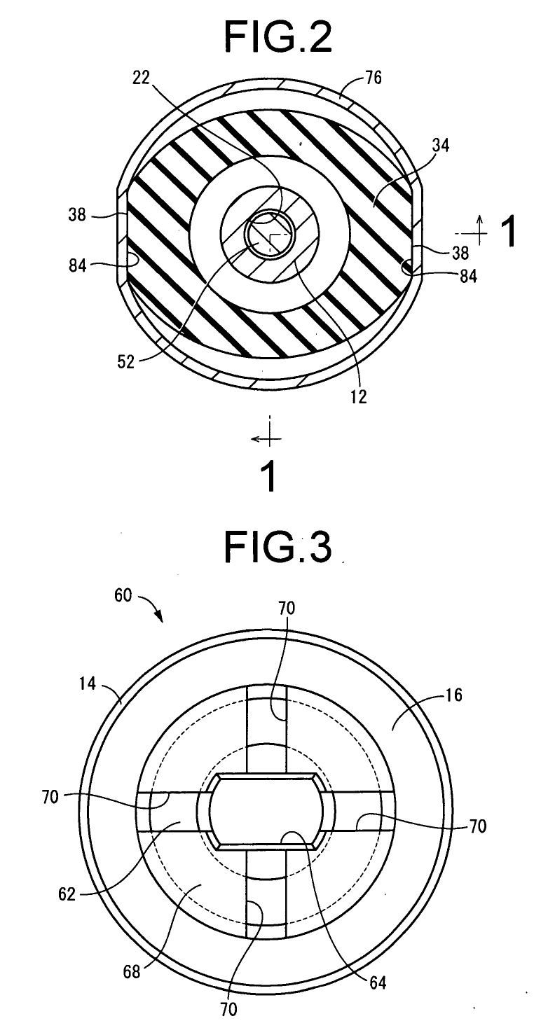

FIGS. 1 and 2 depict a vibration damping device in the form of an automotive engine mount 10 pertaining to a first embodiment of the invention. This engine mount 10 has a structure in which a first mounting member 12 of metal and a second mounting member 14 of metal, are elastically connected together via a main rubber elastic body 16 as depicted in FIG. 3. The first mounting member 12 is fastened via a power unit-side bracket 18 to a power unit constituting a first member to be linked in a vibration damping fashion, while the second mounting member 14 is fastened via an outer bracket 20 to a vehicle body constituting the other member to be linked in a vibration damping fashion, whereby the power unit is supported in vibration damped fashion on the vehicle body. FIGS. 1 and 2 depict the engine mount 10 as it appears when not installed in an automobile. In the present embodiment, with the engine mount 10 in the installed state, the distributed support load of the power unit will be input in the axial direction of the mounting (the vertical in FIG. 1), whereupon on the basis of elastic deformation of the main rubber elastic body 16 the first mounting member 12 and the second mounting member 14 will undergo displacement in the direction of moving closer together. The principal direction of vibration input will be generally coincident with the axial direction of the mounting. In the description hereinbelow the vertical direction shall refer to the vertical direction in FIG. 1 unless indicated otherwise.

To describe in greater detail, the first mounting member 12 has a small-diameter, generally circular cylinder shape overall, having a bolt fastening hole 22 formed in its center portion. The axial lower end of the first mounting member 12 increases in diameter so as to flare outwardly in the axis-perpendicular direction, forming an abutting portion 24 of large-diameter round disk shape. On the axial lower end face 26 of the abutting portion 24 in the center portion thereof is formed a stopper projection 28 of inverted frustoconical shape facing downward. A flat lower end face 26 of annular shape is formed on the outside peripheral portion from this stopper projection 28, for serving as a superposed face.

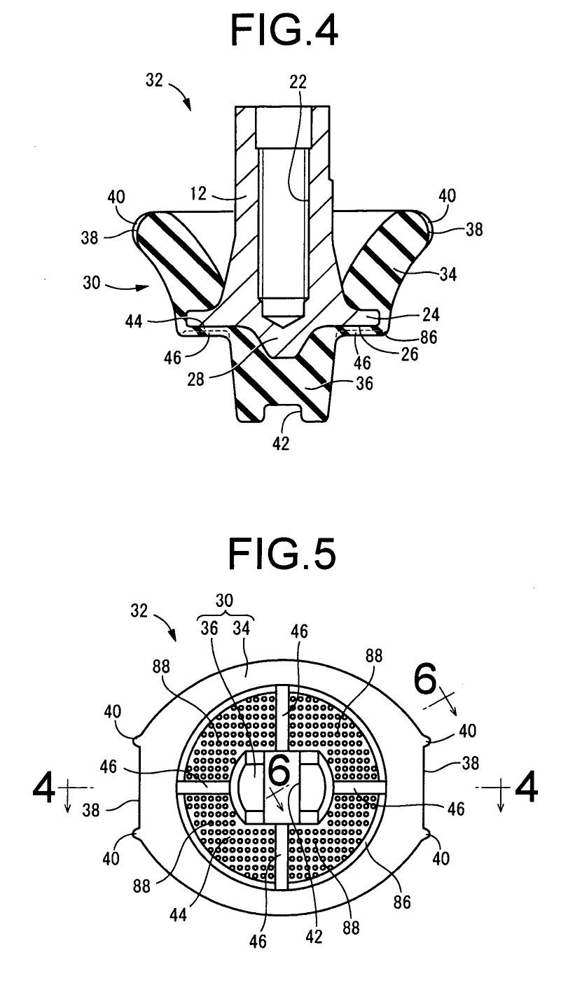

As shown in FIGS. 4 and 5 as well, the first mounting member 12 comprising the abutting portion 24 and the stopper projection 28 is integrally vulcanization molded with a stopper rubber 30. That is, the stopper rubber 30 constitutes a first integrally vulcanization molded component 32 that incorporates the first mounting member 12. This stopper rubber 30 includes a rebound cushion rubber 34 and a bound cushion rubber 36.

The rebound cushion rubber 34 is of generally elliptical shape in plan view, and extends upward from the upper end portion of the abutting portion 24 and the axial lower end portion of the first mounting member 12. The inside peripheral face and outside peripheral face of the rebound cushion rubber 34 are constituted as curving faces that gradually slope outwardly in the axis-perpendicular direction moving upward. Based on the fact that the rebound cushion rubber 34 is of elliptical shape, the outside peripheral face of the rebound cushion rubber 34 in the major axis direction thereof (sideways in FIGS. 4 and 5) is sloped outwardly in the axis-perpendicular direction to a greater extent than the minor axis direction thereof (the vertical in FIG. 5).

An abutting face 38 of flat shape is formed on the outside face of the rebound cushion rubber 34, at each of the two major axis sides thereof. Specifically, the outside peripheral face of the rebound cushion rubber 34 spreads out in the circumferential direction with a shape squared off on two sides that incorporates the pair of abutting faces 38, 38. At the two circumferential edges of each abutting face 38 are integrally formed pressure lips 40 which extend with generally unchanging semicircular cross section in the axial direction.

The bound cushion rubber 36, on the other hand, has a generally truncated pyramid shape, and the first mounting member 12 is vulcanization bonded to the center of the upper end portion thereof, so that the stopper projection 28 of the first mounting member 12 is embedded therein. At the projecting distal end of the bound cushion rubber 36 is formed a recessed groove 42 extending in a straight line along an axis (the vertical in FIGS. 3 and 5) in the axis-perpendicular direction, which represents the minor axis direction of the bound cushion rubber 36 and the rebound cushion rubber 34.

On the lower end face 26 of the abutting portion 24 of the first mounting member 12 is formed a cushion rubber layer 44 as a cushion rubber layer integrally formed with the stopper rubber 30. The cushion rubber layer 44 spreads out over the lower end face 26 of the abutting portion 24 around the bound cushion rubber 36, with generally unchanging thickness dimension throughout. An inside peripheral edge portion of the cushion rubber layer 44 is integrally formed with the basal end portion of the bound cushion rubber 36, while an outside peripheral edge portion runs around the abutting portion 24 from the outside peripheral edge to the upper end, and is integrally formed with the lower end portion of the rebound cushion rubber 34.

Four projecting ribs 46, 46, 46, 46 project from the cushion rubber layer 44. These projecting ribs 46 extend with generally unchanging rectangular or semicircular cross section, from the basal end of the bound cushion rubber 36 towards the outside peripheral edge portion of the cushion rubber layer 44, and are spaced at generally equal intervals in the circumferential direction. In the present embodiment in particular, one pair of projecting ribs 46, 46 are disposed on a line lying on an axis (sideways in FIG. 5) in the axis-perpendicular direction, to either side of the center axis of the first integrally vulcanization molded component 32 which represents the major axis direction of the bound cushion rubber 36. Another pair of projecting ribs 46, 46 are disposed on a line lying on an axis orthogonal thereto (the vertical in FIG. 5) in the axis-perpendicular direction, to either side of the center axis of the first integrally vulcanization molded component 32 which represents the minor axis direction of the bound cushion rubber 36.

The power unit-side bracket 18 is fastened to the first mounting member 12 of the above design. The power unit-side bracket 18 is fabricated of rigid material such as steel, and its structure includes an integrally formed lateral plate 48 of flat plate shape extending in the horizontal direction (sideways in FIG. 1) and a vertical plate 50 of flat plate shape extending in the vertical direction (the vertical in FIG. 1). A fastening bolt 52 is passed through the lateral plate 48 of the power unit-side bracket 18 and is screwed into the bolt fastening hole 22 of the first mounting member 12, while the vertical plate 50 of the power unit-side bracket 18 is fastened with bolts or the like to the power unit, not shown, whereby the first mounting member 12 is fixedly mounting onto the power unit via the power unit-side bracket 18.

A bound stopper rubber 51 of large-diameter, generally bottomed round tubular shape open at the bottom is disposed on the lateral plate 48 of the power unit-side bracket 18. The upper end face of the bound stopper rubber 51 is secured superposed against the lower end face of the lateral plate 48, while the first mounting member 12 is inserted through the center of its bottom portion.

The second mounting member 14, on the other hand, has a thin-walled, generally large-diameter round tubular shape, with the axial lower end portion of the second mounting member 14 bending in internal flange configuration towards the inside peripheral side. The first mounting member 12 is positioned spaced apart axially above the second mounting member 14, while being in an approximately coaxial arrangement. The main rubber elastic body 16 is positioned between the first mounting member 12 and the second mounting member 14.

The main rubber elastic body 16 has a generally frustoconical shape overall, and takes the form of a rotation-symmetric body having generally unchanging cross section about its entire circumference. The inside peripheral face of the second mounting member 14 is vulcanization bonded in its entirety to the outside peripheral face of the large-diameter end of the main rubber elastic body 16. At the large-diameter end (face) of the main rubber elastic body 16 is formed a generally conical shaped recess 54 that opens downward. In this embodiment in particular, owing to considerations such as a difference in spring properties required in the vehicle front-back direction versus the vehicle sideways direction, a pair of generally fan-shaped lightening portions 56, 56 are formed along an axis lying in the axis-perpendicular direction, on the floor of the recess 54.

To the small-diameter end of the main rubber elastic body 16, a pressure-receiving fitting 58 is vulcanization bonded, functioning as a reinforcing member, that is superposed against the small-diameter end face so as to open upward. That is, the main rubber elastic body 16 is formed as a second integrally vulcanization molded component 60 that incorporates the second mounting member 14 and the pressure-receiving fitting 58.

The pressure-receiving fitting 58 is composed, for example, of a press-molded component formed by press molding of a sheet of metal or other rigid material. This pressure-receiving fitting 58 has a thin-walled, generally circular cup shape. The pressure-receiving fitting 58, at the rim of the opening of its main body section of the bottomed, round tubular shape, has integrally formed thereon a flanged portion 62 of annular plate shape spreading out in the axis-perpendicular direction. In this embodiment in particular, the inside diameter dimension of the flanged portion 62 (the diameter of the opening of the main body section of the pressure-receiving fitting 58) is made smaller than the outside diameter dimension of the abutting portion 24 of the first mounting member 12, while the outside diameter dimension of the flanged portion 62 is larger than the outside diameter dimension of the abutting portion 24.

An inside face rubber layer formed so as to cover generally the entire face on the inside of the pressure-receiving fitting 58 is integrally formed with the main rubber elastic body 16, via a hole perforating the bottom wall of the pressure-receiving fitting 58. With this arrangement, to the inside of the pressure-receiving fitting 58, there is formed a mating recess 64 which opens upward. This mating recess 64, which takes the form of a recess formed in the center portion of the opposing faces of the first mounting member 12 and the pressure-receiving fitting 58, opens onto the small-diameter end (face) of the main rubber elastic body 16, and has a shape slightly larger than the shape of the outside peripheral face of the bound cushion rubber 36. In particular, the depth dimension of the mating recess 64 is smaller than the height dimension of the bound cushion rubber 36 projecting axially downward from the first mounting member 12.

An upper end face 66 of the flanged portion 62 of the pressure-receiving fitting 58 serves as a superposed face, and is covered by a cushion rubber layer 68 integrally formed with the main rubber elastic body 16, by extending the mounting member up over to the top of the pressure-receiving fitting 58. This cushion rubber layer 68, which functions as a covering rubber layer, is of annular shape spreading out with a generally unchanging thickness dimension. The cushion rubber layer 68 is furnished with four air release grooves 70, 70, 70, 70 functioning as air venting grooves. The air release grooves 70 extend in the axis-perpendicular direction with generally unchanging cross section, with their floor portions (faces) reaching the upper end face 66 of the flanged portion 62. The air release grooves 70 at one end thereof open onto the inside peripheral edge of the cushion rubber layer 68 and connect with the mating recess 64, while the air release grooves 70 at the other end thereof open onto the outside peripheral edge of the cushion rubber layer 68 and connect with the outside. In this embodiment in particular, the air release grooves 70 are spaced at generally equal intervals in the circumferential direction, with one pair of air release grooves 70 being disposed on an axis in the axis-perpendicular direction coincident with the direction of opposition of pair of lightening portions 56, 56, and with another pair of air release grooves 70 being disposed on an axis in the axis-perpendicular direction orthogonal thereto, i.e., on an axis coincident with the areas devoid of the pair of lightening portions 56, 56. The depth dimension of the air release grooves 70 is the same as or slightly smaller than the height of the projecting ribs 46 projecting downward from the cushion rubber layer 44.

In the first integrally vulcanization molded component 32 and the second integrally vulcanization molded component 60, the bound cushion rubber 36 is fitted into the mating recess 64, with the distal end portion of the bound cushion rubber 36 abutting the floor of the pressure-receiving fitting 58 via the rubber of the floor of the mating recess 64, and with the bound cushion rubber 36 undergoing compressive deformation in the axial direction. In other words, the stopper projection 28 disposed on the center portion of the first mounting member 12 comes into cushioned abutment against the floor of the pressure-receiving fitting 58 via the bound cushion rubber 36 and the floor rubber of the mating recess 64. The outside dimensions of the bound cushion rubber 36 are smaller by a prescribed amount than the inside dimensions of the mating recess 64, whereby when the bound cushion rubber 36 undergoes compressive deformation in the axial direction to fit inside the mating recess 64, a gap 72 is formed all the way around the circumference, between the bound cushion rubber 36 and the mating recess 64.

The projecting ribs 46 disposed projecting from the cushion rubber layer 44 of the first mounting member 12 fit into the air release grooves 70 formed in the cushion rubber layer 68 of the pressure-receiving fitting 58 (the flanged portion 62), with the distal end portions of the projecting ribs 46 in contact against the upper end face 66 of the flanged portion 62, and with the projecting ribs 46 undergoing compressive deformation in the axial direction. By making the width dimension of the projecting rib 46 smaller by a prescribed amount than the width dimension of the air release groove 70, when the projecting rib 46 undergoes compressive deformation to fit within the air release groove 70, a gap of prescribed size is situated between the widthwise edges of the projecting rib 46 and the sidewalls of the air release groove 70.

By means of this design, the lower end face 26 of the abutting portion 24 of the first mounting member 12 is superposed against the upper end face 66 of the flanged portion 62 of the pressure-receiving fitting 58, via the cushion rubber layer 44 situated on the first mounting member 12 side and the cushion rubber layer 68 situated on the pressure-receiving fitting 58 side. Consequently, the first integrally vulcanization molded component 32 incorporating the first mounting member 12 is positioned against the second integrally vulcanization molded component 60 incorporating the main rubber elastic body 16, superposed from above it in the axial direction and on approximately the same center axis therewith, and assembled an unbonded state permitting separation in the axial direction. By means of the bound cushion rubber 36 fitting within the mating recess 64, and the projecting ribs 46 fitting within the respective prescribed air release grooves 70, the first integrally vulcanization molded component 32 and the second integrally vulcanization molded component 60 are positioned in the circumferential direction and in the axis-perpendicular direction, preventing them from rotating with respect to one another.

In the present embodiment in particular, before the abutting portion 24 of the first mounting member 12 and the flanged portion 62 of the pressure-receiving fitting 58 come into abutment via the cushion rubber layers 44, 68, in the center portion of the first mounting member 12 and the pressure-receiving fitting 58, the stopper projection 28 of the first mounting member 12 comes into cushioned abutment with the floor of the pressure-receiving fitting 58 via the bound cushion rubber 36 of the first mounting member 12.

The outer bracket 20 is attached fitting externally onto the first integrally vulcanization molded component 32 and the second integrally vulcanization molded component 60. The outer bracket 20 is of stepped, generally round tubular shape having a shoulder portion 74 in its axial medial section, with a small-diameter tube portion 76 serving as a tubular projecting portion situated to the upper side of the shoulder portion 74, and a large-diameter tube portion 78 larger in diameter than the small-diameter tube portion 76 situated to the lower side of the shoulder portion 74. At the axial upper end of the small-diameter tube portion 76, there is integrally formed an abutting piece 80 of inner flange form extending inward in the axis-perpendicular direction and functioning as a rebound stopper. At the axial lower end of the large-diameter tube portion 78, there is integrally formed mounting plate portion 82 of flange form extending outward in the axis-perpendicular direction. Abutted faces 84 of flat shape are formed in each of two areas of the small-diameter tube portion 76, located in opposition along an axis in the axis-perpendicular direction. Specifically, the inside peripheral face of the small-diameter tube portion 76 extends in the circumferential with a shape squared off on two sides, that incorporates the pair of abutted faces 84, 84.

The first integrally vulcanization molded component 32 is inserted through the opening at the lower end of the outer bracket 20 and into the small-diameter tube portion 76 where it is positioned housed therein, while the second integrally vulcanization molded component 60 is inserted into the large-diameter tube portion 78 and positioned in the axial direction with the upper end face of the second mounting member 14 abutting the shoulder portion 74 of the outer bracket 20, and with the second mounting member 14 secured press-fit in the large-diameter tube portion 78 of the outer bracket 20. With this arrangement, the first integrally vulcanization molded component 32 and the second integrally vulcanization molded component 60 are securely attached to the outer bracket 20, in a state of being superposed in the axial direction on approximately the same center axis. The mounting plate portion 82 of the outer bracket 20 is fastened with bolts or the like to a member on the vehicle body side (not shown), whereby the second mounting member 14 is fastened to the vehicle body via the outer bracket 20.

In this assembled state, the abutting portion 24 of the first mounting member 12 and the abutting piece 80 of the outer bracket 20 are positioned in opposition to and spaced apart from one another in the axial direction. The rebound cushion rubber 34 at the projecting distal end face thereof abuts the lower face of the abutting piece 80, and on the basis of elastic deformation of the main rubber elastic body 16 undergoes elastic deformation between the axially opposed faces of the abutting portion 24 of the first mounting member 12 and the abutting piece 80. In particular, the distal end portion of the rebound cushion rubber 34 is arranged such that areas thereof situated in opposition in the major axis direction (sideways in FIG. 2), i.e. areas where the abutting faces 38 and the pressure lips 40 are situated, are disposed in abutment against the abutting piece 80 and the small-diameter tube portion 76 of the outer bracket 20 in the axial direction and the axis-perpendicular direction, while areas thereof situated in opposition in the minor axis direction (the vertical in FIG. 2) are disposed spaced diametrically apart from the small-diameter tube portion 76 and in abutment in the axial direction against the abutting piece 80 only. As will be apparent from the above, in the present embodiment, a rebound stopper member incorporating the abutting piece 80 situated in opposition to and spaced apart to the outside in the axial direction from the abutting portion 24 of the first mounting member 12 is constituted so as to include the outer bracket 20. The rebound cushion rubber 34 is installed in a state of preliminary compressive deformation, even before the engine mount 10 is installed on the vehicle.

The small-diameter tube portion 76 of the outer bracket 20 is positioned to the inside of the bound stopper rubber 51 of the power unit-side bracket 18, while the abutting piece 80 of the small-diameter tube portion 76 and the floor of the bound stopper rubber 51 are disposed in opposition to one another a prescribed distance apart in the axial direction.

One or more passage holes may be provided at suitable locations on the small-diameter tube portion 76 of the outer bracket 20, between the portion thereof abutted by the rebound cushion rubber 34 and the portion to which the second mounting member 14 is fastened (i.e. the large-diameter tube portion 78 and the shoulder portion 74). With this arrangement, it is possible for water or the like infiltrating into the outer bracket 20 from between the first mounting member 12 and the abutting piece 80 of the outer bracket 20 to drain out through these passage holes.

The abutting faces 38 disposed on the outside peripheral portion of the rebound cushion rubber 34 in the major axis direction (sideways in FIG. 2) are superposed against the abutted faces 84 of the small-diameter tube portion 76, while the rebound cushion rubber 34 undergoes compressive deformation in the axial and axis-perpendicular directions. The pressure lips 40 disposed on the rebound cushion rubber 34 undergo compressive deformation in abutment against portions corresponding to the abutted faces 84 of the small-diameter tube portion 76. Thus, the first integrally vulcanization molded component 32 and the outer bracket 20, and hence the second integrally vulcanization molded component 60 fastened to the outer bracket 20, are prevented from rotating relative to one another in the circumferential direction.

In particular, at the lower end face 26 of the abutting portion 24 and the upper end face 66 of the flanged portion 62 where the abutting portion 24 of the first mounting member 12 and the flanged portion 62 of the pressure-receiving fitting 58 of the main rubber elastic body 16 are superposed, the upper and lower end faces 26, 66 thereof and the cushion rubber layers 44, 68 covering these lower end faces 26, 66 are each of annular shape, with the cushion rubber layer 44 covering the lower end face 26 being larger in diameter than the cushion rubber layer 68 covering the upper end face 66. The cushion rubber layer 44 of the lower end face 26 is slightly smaller in diameter than the flanged portion 62. The outside peripheral edge of the cushion rubber layer 44 covering the lower end face 26 of the abutting portion 24 is positioned outwardly in the axis-perpendicular direction from the outside peripheral edge of the abutting portion 24.

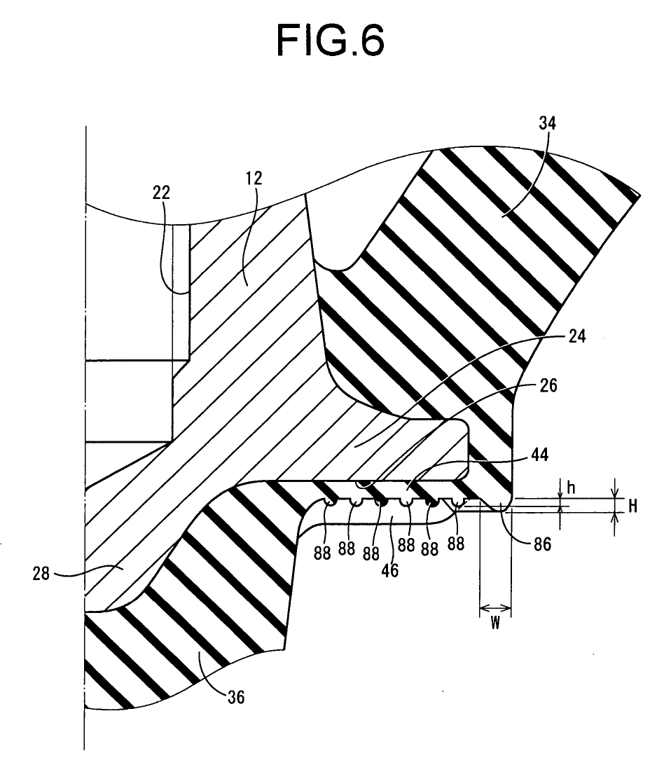

Here, the cushion rubber layer 44 affixed to the abutting portion 24 of the first mounting member 12 covers the abutting portion 24 to the outside peripheral face thereof, and is integrally formed with the stopper rubber 30. That is, the cushion rubber layer 44 has an outside diameter dimension larger than the outside diameter dimension of the abutting portion 24. A seal lip 86 is integrally formed with the cushion rubber layer 44 in the portion thereof which bulges to the outer peripheral side from the abutting portion 24. As depicted in enlarged view in FIG. 6, the seal lip 86 is situated at the outside peripheral portion of the first mounting member 12 and is formed continuous with the outside peripheral edge portion of the cushion rubber layer 44 all the way around in the circumferential direction. This seal lip 86 is formed with an unchanging, generally semicircular cross section. In the outside peripheral portion of the cushion rubber layer 44 where the projecting ribs 46 are disposed, by extending the projecting ribs 46 out to the outside peripheral portion of the cushion rubber layer 44, these are integrated with the seal lip 86. The height dimension: H of the seal lip 86 projecting downward from the cushion rubber layer 44 is smaller by a prescribed amount than the height dimension of the projecting ribs 46, so while the seal lip 86 appears to be divided by the projecting ribs 46, the projecting ribs 46 may be thought of as covering a seal lip 86 that extends continuously all the way around the circumference.

In this embodiment in particular, the outside peripheral edge of the seal lip 86 is positioned at generally the same location in the axis-perpendicular direction as the outside peripheral portion of the cushion rubber layer 44, whereby the seal lip 86 assumes a form that does not project outwardly in the axis-perpendicular direction beyond the outside peripheral face of the cushion rubber layer 44. The seal lip 86 is situated in a zone of annular shape in plan view of prescribed width dimension extending inward in the axis-perpendicular direction from the outside peripheral edge portion of the cushion rubber layer 44, and extends through this annular zone with a prescribed width dimension: W. The ratio: W/H of seal lip 86 width dimension: W to height dimension: H may be established and modified appropriately depending on the required sealing capability, but is favorably such that 0.5≦W/H≦5, preferably 1≦W/H≦3.

Since the annular zone containing this seal lip 86 is located in the outside peripheral portion of the cushion rubber layer 44, situated outwardly in the axis-perpendicular direction from the center portion of the cushion rubber layer 44 which faces the abutting portion 24 of the first mounting member 12 in the axial direction, the seal lip 86 is positioned at a location to the outer peripheral side from the first mounting member 12 and the abutting portion 24. Based on the fact that the outside diameter dimension of the cushion rubber layer 44 is smaller than the outside diameter dimension of the flanged portion 62 of the pressure-receiving fitting 58, the seal lip 86 is positioned opposite the outside peripheral portion of the flanged portion 62 in the axial direction.

The projecting distal end of the seal lip 86 which as a generally mountain-shaped cross section is eccentric towards the outer peripheral side (to the right in FIG. 6) from the lateral center of the basal end portion of the seal lip 86. The cross section of the seal lip 86 thereby takes a form sloping towards the outer peripheral side (to the right in FIG. 6) all the way around in the circumferential direction.

A plurality of small projections 88 functioning as grain-like elastic projections are disposed on the cushion rubber layer 44 diametrically inward from the seal lip 86. The small projections 88 are of generally semispherical shape integrally formed with the cushion rubber layer 44 and projecting by a prescribed height: h downward from the cushion rubber layer 44. The plurality small projections 88 are spaced apart by a prescribed distance in the axis-perpendicular direction. The ratio: H/h of seal lip 86 height dimension: H to small projection 88 height dimension: h may be established on the basis of desired sealing capability, noise suppressing effect and so on, and is not limited in any particular way; it may be for example, 1≦H/h≦10, favorably 1.2≦H/h≦5.

When the automotive engine mount 10 constructed as described above is installed in an automobile by fastening the first mounting member 12 to the power unit via the power unit-side bracket 18 while fastening the second mounting member 14 to the vehicle body via the outer bracket 20, on the basis of elastic deformation of the main rubber elastic body 16 produced by the distributed support load of the power unit, the first mounting member 12 and the second mounting member 14 undergo relative displacement in the direction of moving closer together in the axial direction. Also, the rebound cushion rubber 34 that in the uninstalled state was in compressive deformation in abutment against the abutting piece 80 now moves away from the abutting piece 80, while the lateral plate 48 of the power unit-side bracket 18 and the abutting piece 80 undergo relative displacement in the direction of moving closer together in the axial direction.

When vibrational load is input in the axial direction and the first mounting member 12 and the second mounting member 14 undergo relative displacement away from each other in the axial direction, the abutting portion 24 of the first mounting member 12 comes into abutment against the abutting piece 80 of the outer bracket 20 via the rebound cushion rubber 34. Displacement of the first mounting member 12 and the second mounting member 14 in the direction of moving apart in the axial direction (i.e. the rebound direction) is thereby limited in a cushioned manner. The rebound stopper mechanism pertaining to the present embodiment is constituted to include the abutting portion 24 of the first mounting member 12, the abutting piece 80 of the outer bracket 20, and the rebound cushion rubber 34.

Meanwhile, when vibrational load is input in the axial direction and the first mounting member 12 and the second mounting member 14 undergo relative displacement closer together in the axial direction by more than a prescribed amount, lateral plate 48 of the power unit-side bracket 1 8 and the abutting piece 80 of the outer bracket 20 come into abutment via the bound stopper rubber 51. Displacement of the first mounting member 12 and the second mounting member 14 in the direction of moving closer together in the axial direction (i.e. the bound direction) is thereby limited in a cushioned manner. The rebound stopper mechanism pertaining to the present embodiment is constituted to include the lateral plate 48 of the power unit-side bracket 18, the abutting piece 80 of the outer bracket 20, and the bound stopper rubber 51.

A separate rebound stopper mechanism pertaining to the present embodiment is constituted to include the stopper projection 28 of the first mounting member 12, the pressure-receiving fitting 58, the bound cushion rubber 36, and the floor rubber of the mating recess 64 of the main rubber elastic body 16. Specifically, when the cushion rubber layer 44 covering the abutting portion 24 of the first mounting member 12, and the cushion rubber layer 68 covering the flanged portion 62 of the pressure-receiving fitting 58, move into abutment with one another from the separated state, the stopper projection 28 and the pressure-receiving fitting 58 come into contact via the bound cushion rubber 36 and the floor rubber of the mating recess 64, even before the two cushion rubber layers 44, 68 come into contact. As a result, the level of displacement of the first mounting member 12 and the second mounting member 14 in the bound direction is limited in a cushioned manner.

In particular, in this kind of engine mount 10, the first mounting member 12 is constituted as a separate structure independent from the main rubber elastic body 16 and is superposed separably thereagainst, when the first mounting member 12 and the second mounting member 14 undergo relative displacement in the rebound direction by more than a prescribed amount. Accordingly, the cushion rubber layer 44 covering the abutting portion 24 of the first mounting member 12 and the cushion rubber layer 68 covering the flanged portion 62 of the pressure-receiving fitting 58 move away from one another, while depending on the level of rebound displacement, the bound cushion rubber 36 projecting from the first mounting member 12 and the floor rubber of the mating recess. 64 of the main rubber elastic body 16 may also move away from one another. As a result, tensile stress and strain of the main rubber elastic body 16 is reduced, and excellent endurance is attained.

As discussed previously, the lower end face 26 of the abutting portion 24 of the first mounting member 12 and the upper end face 66 of the flanged portion 62 of the pressure-receiving fitting 58, which are superposed against one another via the cushion rubber layers 44, 68, are constituted as mutually separable structures. Consequently, there is a risk that if water, oil or the like should infiltrate into the outer bracket 20 due to unforeseen rainfall, flood, car trouble or the like, the water or oil may infiltrate between the superposed upper end face 66 and lower end face 26.

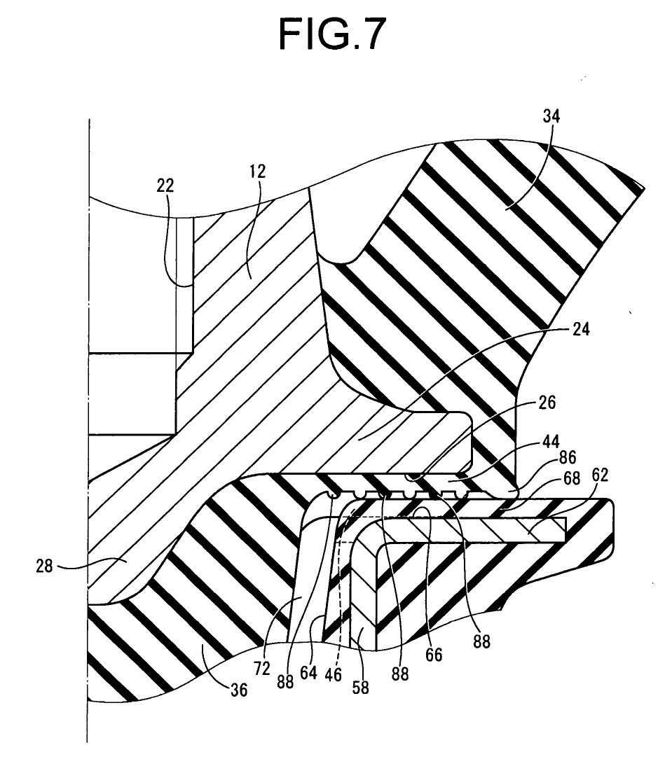

For this reason, the seal lip 86 is disposed in the outside peripheral portion of the cushion rubber layer 44 on the lower end face 26 of the abutting portion 24, and when as depicted in FIG. 7 the cushion rubber layer 44 on the lower end face 26 is superposed against the cushion rubber layer 68 of the upper end face 66 of the flanged portion 62, the seal lip 86 undergoes elastic deformation throughout its entirely and comes into abutment in intimate contact against the cushion rubber layer 68 of the upper end face 66. As a result, the superposed lower end face 26 and upper end face 66 are sealed fluid-tightly, effectively preventing water, oil or the like from infiltrating between the superposed faces.

The seal lip 86 pertaining to this embodiment in particular is disposed in the outside peripheral portion of the cushion rubber layer 44 away to the outer peripheral side from the abutting portion 24 of the first mounting member 12. It is possible thereby to prevent the desired spring properties produced through abutment and separation of the first mounting member 12 and the pressure-receiving fitting 58 of the main rubber elastic body 16 from being altered appreciably due to abutment and separation via the seal lip 86.

Further, by designing the cross sectional shape of the seal lip 86 so that it inclines towards the outer peripheral side all the way around in the circumferential direction, when the lower end face 26 of the abutting portion 24 of the first mounting member 12 is superposed against the upper end face 66 of the flanged portion 62 of the pressure-receiving fitting 58, the seal lip 86 will readily undergo elastic deformation towards the outer peripheral side. That is, the direction of elastic deformation by the seal lip 86 can be defined consistently on the basis of the cross sectional shape of the seal lip 86, thereby affording more reliable sealing capability between the superposed faces.

Additionally, since the seal lip 86 is disposed on the cushion rubber layer 44 of the abutting portion 24 of the first mounting member 12, which is smaller in diameter than the cushion rubber layer 68 of the flanged portion 62 of the pressure-receiving fitting 58, sufficient contact area for the seal lip 86 is assured. Consequently, even in the event that, for example, the center axes of the first mounting member 12 and the second mounting member 14 become misaligned due to irregular displacement of the two mounting members 12, 14 so that the seal lip 86 becomes eccentric with respect to the center axis of the pressure-receiving fitting 58 (second mounting member 14) when it comes into contact with the cushion rubber layer 68, the seal lip 86 will nevertheless undergo elastic deformation consistently, to consistently afford the desired sealing capability.

It would be possible to achieve effects substantially identical to the effects described previously obtained by providing the seal lip 86, by means of furnishing the flanged portion 62 of the pressure-receiving fitting 58 with an upwardly-projecting lip similar to the seal lip 86. However, in the present embodiment in particular, at the superposed faces of the abutting portion 24 of the first mounting member 12 and the flanged portion 62 of the pressure-receiving fitting 58, a downwardly-projecting seal lip 86 is furnished only to the cushion rubber layer 44 of the abutting portion 24 which is situated on the lower side in the vertical direction with the mounting installed on the automobile. By employing such a construction, in addition to the effects mentioned above, there is a further advantage that water and the like can be prevented from readily pooling on the surface of the cushion rubber layer 68, on the inside peripheral side of the seal lip 86.

Consequently, the engine mount 10 of the present embodiment, by virtue of being furnished with the seal lip 86 of the design described above, maintains the desired spring properties well, while on the basis of the excellent sealing capability can advantageously prevent the occurrence of “squeal” or other noise during juxtaposition, caused by water or the like infiltrating between the superposed faces of the abutting portion 24 of the first mounting member 12 and the flanged portion 62 of the pressure-receiving fitting 58.

Also, in the present embodiment, a plurality of small projections 88 are disposed on the inside peripheral side of the cushion rubber layer 44 furnished with the seal lip 86, and when the cushion rubber layer 44 on the first mounting member 12 side and the cushion rubber layer 68 on the main rubber elastic body 16 side are superposed against one another, the seal lip 86 undergoes elastic deformation in contact against the cushion rubber layer 68, while the plurality of small projections 88 come into contact against the cushion rubber layer 68. The two cushion rubber layers 44, 68 are thereby prevented from becoming superposed in intimate contact with one another, so that noise occurring in association with juxtaposition is more advantageously suppressed. By giving the small projections 88 semispherical shape and higher spring constant than the spring constant of the seal lip 86, relative hard spring properties are produced with respect to the small projections 88. Consequently, large change in spring properties of the mount 10, due to the presence of the small projections 88 between the abutting portion 24 of the first mounting member 12 and the flanged portion 62 of the pressure-receiving fitting 58, can be suppressed. It is possible thereby to achieve excellent noise reducing action, while maintaining the desired spring properties.

Additionally, in the present embodiment, by providing the cushion rubber layer 68 on the main rubber elastic body 16 side with a plurality of air release grooves 70 that open in the axis-perpendicular direction, air present between the superposed faces can be vented readily air release grooves 70 when the cushion rubber layer 68 is superposed against the cushion rubber layer 44 on the first mounting member 12 side. Consequently, noise caused by air pockets or the like between the superposed faces can be advantageously reduced.

Also, in the present embodiment, the outer bracket 20 is of round tubular shape, while the rebound cushion rubber 34 is of round tubular shape at its basal end portion and of elliptical shape in plan view at its distal end portion. That is, the angle of incline of the rebound cushion rubber 34 outwardly in the diametrical direction in the direction of projection thereof differs along two mutually intersecting axes in the axis-perpendicular direction, namely, the major axis direction (sideways in FIG. 2) and the minor axis direction (the vertical in FIG. 2). By means of this design, the distal end of the rebound cushion rubber 34 is disposed with areas thereof located in opposition in the major axis direction (sideways in FIG. 2), i.e. the areas where the abutting faces 38 and the pressure lips 40 are situated, being disposed in abutment against the abutting piece 80 and the small-diameter tube portion 76 of the outer bracket 20 in the axial direction and the axis-perpendicular direction, and with areas thereof located in opposition in the minor axis direction (the vertical in FIG. 2) being disposed in abutment against the abutting piece 80 only, and spaced apart in the diametrical direction from the small-diameter tube portion 76.

As a result, it is possible for the abutting force exerted by the rebound cushion rubber 34 on the abutting piece 80 and the small-diameter tube portion 76 to be varied between the major axis direction and the minor axis direction. Therefore, tuning of the spring ratio of the two axes in the axis-perpendicular direction can be accomplished easily without specially modifying the design of the main rubber elastic body 16. Thus, the desired spring ratio in the axis-perpendicular direction can be established advantageously while maintaining the desired spring properties of the main rubber elastic body 16 in the axial direction. By installing this automotive engine mount 10 so that, for example, the minor axis direction with low spring properties is aligned with the vehicle front-back direction, and the major axis direction with high spring properties is aligned with the vehicle sideways direction, the ride comfort and driving stability of the vehicle may be advantageously improved.

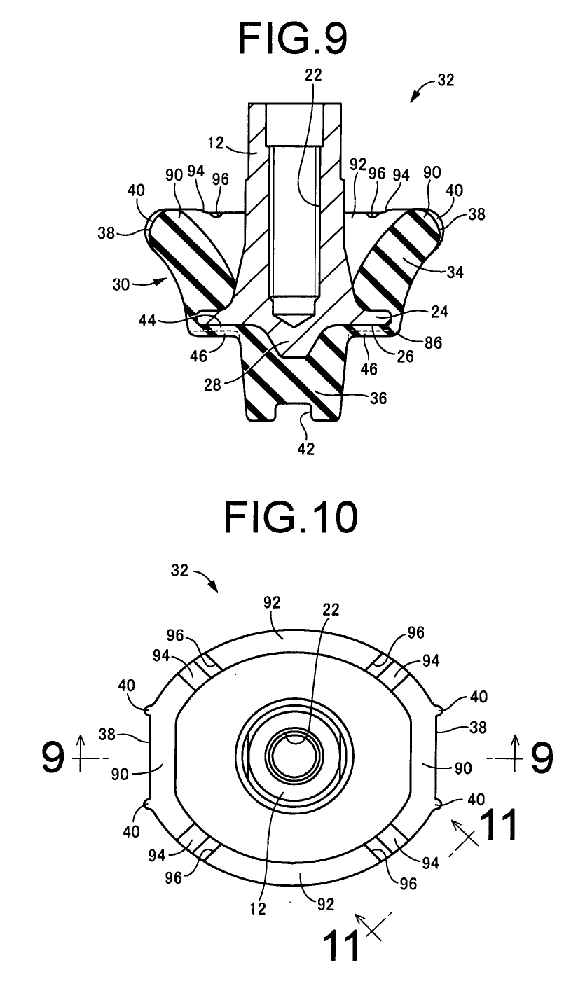

Next, the first integrally vulcanization molded component 32 constituting part of an automotive engine mount according to a second embodiment of the present invention is depicted in FIGS. 9 and 10. In the following description, parts and areas having structures substantially identical with the first embodiment discussed previously are assigned the same symbols as the first embodiment in the drawings, and will not be described in any detail.

In detail, the rebound cushion rubber 34 of the first integrally vulcanization molded component 32 pertaining to the present embodiment incorporates high projecting portions 90 and low projecting portions 92. In the present embodiment, the high projecting portions 90 and low projecting portions 92 are each provided in a pair, formed in alternating fashion in the circumferential direction of the rebound cushion rubber 34, with each extending approximately one-fourth of the way around the circumference of the rebound cushion rubber 34, with unchanging cross section.

The inside peripheral faces and outside peripheral faces of the high projecting portions 90 and low projecting portions 92 are constituted as curving sloped faces that incline gradually outward in the axis-perpendicular direction going upward. The upper end faces of the high projecting portions 90 and low projecting portions 92 are entirely flat in the circumferential direction. The edge portions on the outer peripheral side and the edge portions on the inside peripheral side of the projecting distal end portions of the high projecting portions 90 and low projecting portions 92 have curving shape with approximately the same curvature radius. Edge portions situated on the inside peripheral side of the projecting distal end portions in the circumferentially medial portion of the high projecting portions 90 extend parallel to the abutting faces 38 formed on the outside peripheral portion of the rebound cushion rubber 34.

In the present embodiment in particular, the pair of high projecting portions 90 are disposed in opposition in the major axis direction of the rebound cushion rubber 34 (sideways in FIG. 9 and FIG. 10) to either side of the first mounting member 12 of the first integrally vulcanization molded component 32, while the pair of low projecting portions 92 are disposed in opposition in the minor axis direction of the rebound cushion rubber 34 (the vertical in FIG. 10) to either side of the first mounting member 12.

Here, the high projecting portions 90 are larger than the low projecting portions 92 in terms of their height dimension projecting upward from the abutting portion 24 of the rebound cushion rubber 34. Specifically, in the engine mount assembled from the first integrally vulcanization molded component 32 and the outer bracket 20, the distance in the axial direction between the high projecting portions 90 and the abutting piece 80 of the outer bracket 20 is smaller than distance in the axial direction between the low projecting portions 92 and the abutting piece 80 of the outer bracket 20.

The height differential: h0 between these high projecting portions 90 and low projecting portions 92 are established and modified appropriately depending on the required spring properties, reduction in striking noise, ease of fabrication, and other such considerations, and is not limited to any particular value. In preferred practice, however, it will be set such that h0 is 0.3-5 mm, more preferably such that h0 is 0.8-1.2 mm. If the height differential: h0 is smaller than 0.3 mm, the effect of stepwise contact of the high projecting portions 90 and low projecting portions 92 when the rebound cushion rubber 34 and the abutting piece 80 come into contact may be diminished, or it may become difficult to ensure a gap of sufficient size between the low projecting portions 92 and the abutting piece 80. If on the other hand the height differential: h0 is greater than 5 mm, it becomes difficult to transition smoothly from contact between the high projecting portions 90 and the abutting piece 80 to contact between the low projecting portions 92 and the abutting piece 80, resulting in a risk of nonlinear spring properties, which are undesirable in terms of the required characteristics of the automotive engine mount of the present embodiment.

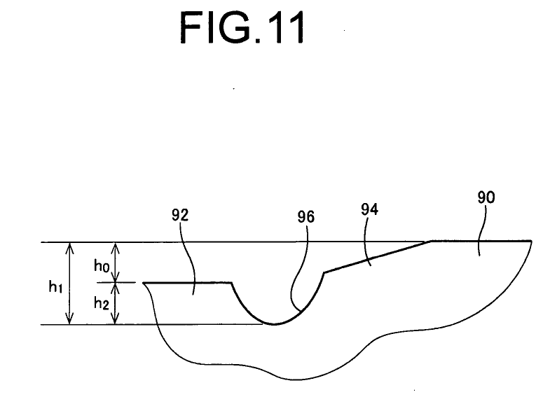

As depicted in enlarged view in FIG. 11, inclined portions 94 and recessed grooves 96 are disposed between the ends of high projecting portions 90 and the ends of low projecting portions 92 situated adjacently to one another in the circumferential direction. Specifically, four sets, each composed of an inclined portion 94 and a recessed groove 96, are provided in medial portions of the rebound cushion rubber 34 in the minor axis direction and major axis direction thereof. Each set of an inclined portion 94 and a recessed groove 96 is disposed between a high projecting portion 90 and a low projecting portion 92 having generally equal length in the circumferential direction, so as to be situated at generally equal intervals in the circumferential direction.

The inclined portions 94 are inclined at a prescribed angle going from the end of the high projecting portion 90 towards the low projecting portion 92, and their surface are generally flat. The recessed grooves 96 are formed between the inclined portion 94 and the low projecting portion 92, in other words, the recessed grooves 96 are formed at both circumferential ends of the low projecting portions 92.

The recessed groove 96 extends in the diametrical direction with generally semicircular cross section, opening onto the upper edge of the rebound cushion rubber 34 while its two diametrical ends open onto the outer peripheral side edge and the inner peripheral side edge of this upper edge. The edge of the recessed groove 96 on one lateral side thereof (the right side in FIG. 11) connects with the lower edge of the inclined portion 94, while the edge of the recessed groove 96 on the other lateral side thereof (the left side in FIG. 11) connects with the circumferential end of the low projecting portion 92. In this embodiment in particular, the lateral edge of the recessed groove 96 connecting with the inclined portion 94 is positioned slightly above the lateral edge thereof connecting with the low projecting portion 92. By means of this design, the high projecting portions 90 and the low projecting portions 92 are connected to one another in the circumferential direction via the inclined portions 94 and the recessed grooves 96. The height differential: h0 between the high projecting portions 90 and the low projecting portions 92 is expressed on the basis of the center floor of the recessed grooves 96 for example, as h0=(axial dimension from high projecting portion 90 upper surface to recessed groove 96 floor: h1)−(axial dimension from low projecting portion 92 upper surface to recessed groove 96 floor, i.e. recessed groove 96 depth dimension: h2).

The automotive engine mount furnished with the first integrally vulcanization molded component 32 constructed as described above enjoys advantages as in the first embodiment. Namely, with the mounting installed in an automobile, the distal end of the rebound cushion rubber 34 is positioned with areas thereof located in opposition in the major axis direction (sideways in FIG. 10) being disposed in abutment against the abutting piece 80 and the small-diameter tube portion 76 of the outer bracket 20 in the axial direction and the axis-perpendicular direction, and with areas thereof located in opposition in the minor axis direction (the vertical in FIG. 10) being disposed in abutment in the axial direction against the abutting piece 80 only, and spaced apart in the diametrical direction from the small-diameter tube portion 76.

The pair of high projecting portions 90, 90 formed in the major axis direction of the rebound cushion rubber 34 undergo elastic deformation in the axial direction in abutment against the abutting piece 80, while the pair of low projecting portions 92, 92 formed in the minor axis direction of the rebound cushion rubber 34 undergo elastic deformation in the axial direction in abutment against the abutting piece 80, but by a level of deformation smaller than the level of deformation of the high projecting portions 90. By means of this arrangement, the abutting force of the high projecting portions 90 and the low projecting portions 92 against the abutting piece 80 acts synergistically with the abutting force the rebound cushion rubber 34 distal end against the abutting piece 80 and the small-diameter tube portion 76, produces an even greater difference in abutting force against the outer bracket 20 along two axes in the axis-perpendicular direction, namely, the major axis direction and minor axis direction of the rebound cushion rubber 34. As a result, tuning of the spring ratio along the two axes in the axis-perpendicular direction can be accomplished easily without specially modifying the design of the main rubber elastic body 16.

Thus, when vibration load is input across the first mounting member 12 the second mounting member 14 in the axial direction (the bound and rebound directions), the rebound cushion rubber 34 is forced to come into abutment with or move away from the abutting piece 80 and the small-diameter tube portion 76. If the rebound load is relatively large, the low projecting portions 92 will come into contact against the abutting piece 80 after the high projecting portions 90 have initially come into contact against the abutting piece 80. That is, by means of the rebound cushion rubber 34 coming into contact with the abutting piece 80 in a stepwise manner from the portions thereof with high projecting height to the portions with low projecting height, the abutting force of the rebound cushion rubber 34 and the abutting piece 80 becomes dispersed. Consequently, stress concentration in the rebound cushion rubber 34 can be reduced and its endurance improved, while advantageously reducing striking noise.

When a relatively small rebound load is input across the first mounting member 12 and the second mounting member 14, the high projecting portions 90 come into contact with the abutting piece 80, while the low projecting portions 92 and the abutting piece 80 remain positioned in opposition by prescribed distance away from each other in the rebound direction. A gap of prescribed size is formed thereby between the low projecting portions 92 and the abutting piece 80, permitting air to flow through this gap. Consequently, it is possible to prevent a condition of suction contact or the like resulting from airtight contact of the entire abutting face 38 of the rebound cushion rubber 34 against the abutting piece 80. Noise that can be produced when the rebound cushion rubber 34 and the abutting piece 80 separate from a condition of suction can also be effectively suppressed thereby.

Specifically, an important technical feature of the engine mount pertaining to the present embodiment is that high projecting portions 90 and low projecting portions 92 of mutually different height dimension are formed in alternating fashion in the circumferential direction of the rebound cushion rubber 34 to provide a plurality of steps in the area thereof which comes into contact with the abutting piece 80, and these steps are utilized to suppress noise which can be produced by contact.

Further research and investigation carried out by the inventors has shown that in order for a sufficient level of noise reducing action to be attained, it is effective to produce large steps in the area of the rebound cushion rubber 34 which comes into contact with the abutting piece 80, and specifically, to create a large height differential: h0 between the high projecting portions 90 and low projecting portions 92. However, if the steps are too large, it is possible that spring properties in the rebound direction may be adversely affected.

With respect to this point, in the present embodiment, the height differential: h0 between the high projecting portions 90 and low projecting portions 92 is set to a relatively small range of 0.3-5 mm, thereby reducing effects on spring properties based on abutment via the rebound cushion rubber 34 between the first mounting member 12 and the second mounting member 14.

When the rebound cushion rubber 34 and the abutting piece 80 come into abutment, the presence of the recessed grooves 96 makes it possible to eliminate the problem of noise produced by suction due to difficulty of ensuring a gap between the low projecting portions 92 and the abutting piece 80, which can be caused by a small height differential: h0 between the high projecting portions 90 and low projecting portions 92.

Specifically, even in cases where it is difficult for a gap to form between the rebound cushion rubber 34 and the abutting piece 80, air present between the abutting faces 38 can be expelled through the recessed grooves 96, thus effectively preventing a condition of contact such as suction. Consequently, even where the height differential: h0 of the high projecting portions 90 and low projecting portions 92 has been set to a small value, there will be no trouble in relation to contact noise. Meanwhile, smooth transition from contact of the high projecting portions 90 to contact of the low projecting portions 92 against the abutting piece 80 of the rebound cushion rubber 34 can be achieved, so that the desired linear spring properties are consistently attained.

Since the recessed grooves 96 are furnished at the two circumferential ends of the low projecting portions 92, the rubber surfaces of the low projecting portions 92 and the high projecting portions 90 extend with sufficient continuity in the circumferential direction. The rebound cushion rubber 34 comes into stable abutment against the abutting piece 80 thereby, and the desired spring properties are advantageously attained. Additionally, since the recessed grooves 96 are situated at locations away from the circumferential center portions of the high projecting portions 90 and the low projecting portions 92 which constitute the principally areas of contact of the rebound cushion rubber 34 against the abutting piece 80, the spring ratio along two axes in the axis-perpendicular direction can be established more advantageously.

Further, in the present embodiment, the high projecting portions 90 and the recessed grooves 96 connect with one another via inclined portions 94, thus reducing stress concentrations or strain that could be caused by a sharp increase in height dimension differential. Also, the fact that the inclined portions 94 and the low projecting portions 92 are connected via the recessed grooves 96 means reduced stress concentrations and strain in the inclined portions 94 as well. Consequently, durability can be more advantageously achieved.

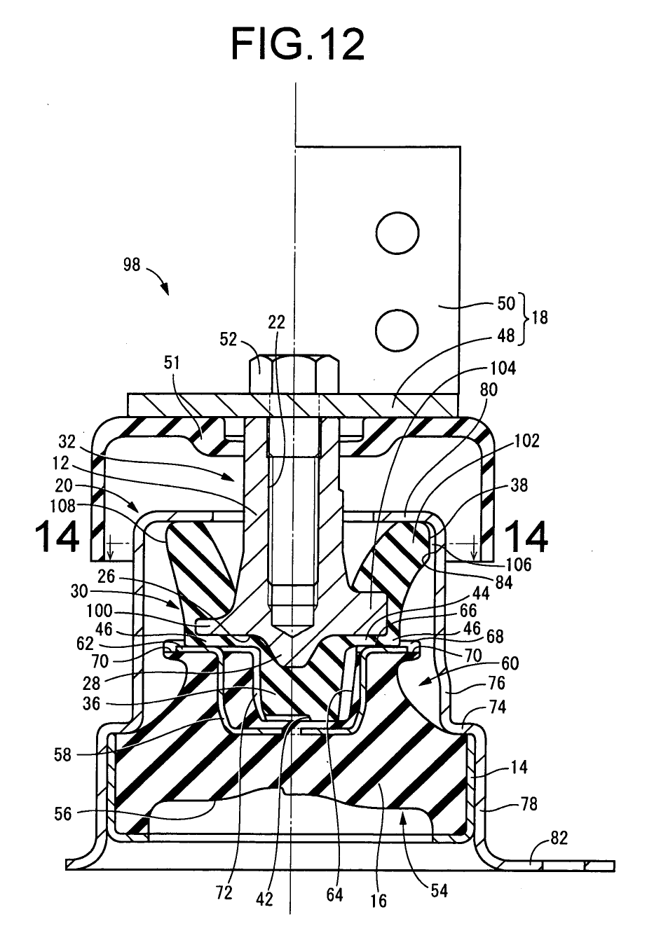

Next, an automotive engine mount 98 pertaining to a third embodiment of the present invention is depicted in FIG. 12. In the following description, parts and areas having structures substantially identical with the first and second embodiments discussed previously are assigned the same symbols as the first and second embodiments in the drawings, and will not be described in any detail.

In this automotive engine mount 98, an abutting portion 100 of large-diameter disk shape integrally formed with the first mounting member 12 is imparted with substantial thickness in a portion thereof in the circumferential direction, and is positioned with its a rebound cushion rubber 102 spaced apart all the way around in the axis-perpendicular direction from the small-diameter tube portion 76 of the outer bracket 20.

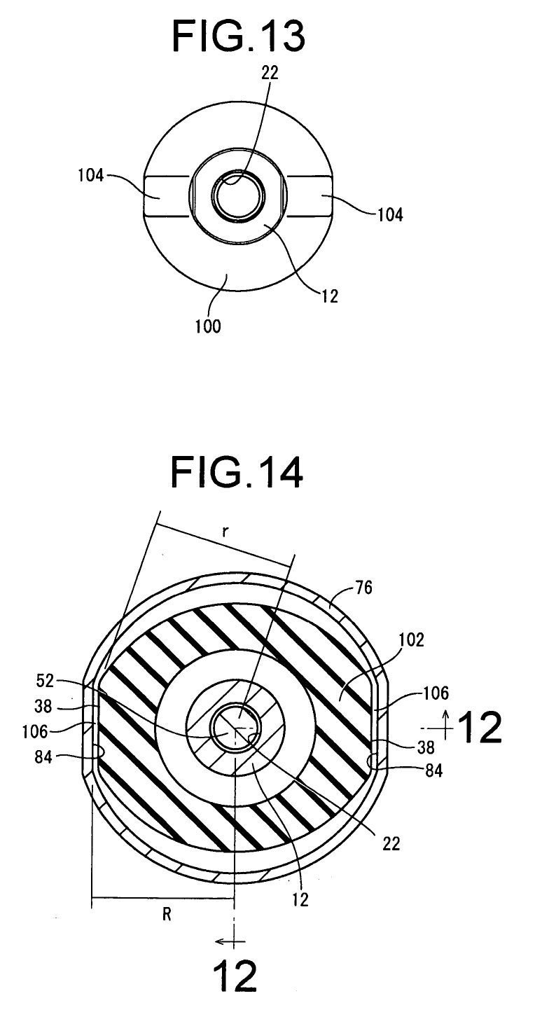

To describe in greater detail, as shown in FIG. 13, on the abutting portion 100 disposed at the lower end of the first mounting member 12 there are formed a pair of projecting portions 104, 104 constituted as thick portions situated at both sides along one axis in the diametrical direction thereof. The projecting portions 104 project axially upward from the upper face of the abutting portion 100, and are formed so as to extend in a straight line in the diametrical direction, with generally unchanging cross section. Since the lower end face 26 of the abutting portion 100 is generally flat, as shown in FIGS. 12 and 13, the thickness of the abutting portion 100 varies in the circumferential direction, by means of the projecting portions 104 being formed in portions in the circumferential direction so that the upper surface of the abutting portion 100 projects axially upward. With this arrangement, on the circumference of the abutting portion 100, distance of axial separation between the abutting piece 80 of the outer bracket 20 and the abutting portion 100 in the portions thereof where the projecting portions 104 are formed is smaller than the distance of separation in other portions.

The pair of projecting portions 104, 104 in the present embodiment are formed on the upper surface of the abutting portion 100, in such as way as to be situated at both sides in the major axis direction of the projecting distal end portion of the rebound cushion rubber 102, which is of elliptical shape. By means of this design, the axial projecting dimension at the two sides in the major axis direction of the rebound cushion rubber 102 affixed to the abutting portion 100 is smaller than the axial projecting dimension at the two sides in the minor axis direction.

In the present embodiment, as shown in FIG. 14, a pair of abutting faces 38, 38 are formed on the outside peripheral face at both sides in the major axis direction of the projecting distal end portion of the rebound cushion rubber 102, while a pair of abutted faces 84, 84 are formed on the inside peripheral face at both sides along one axis of the outer bracket 20 in the axis-perpendicular direction. With the first integrally vulcanization molded component 32 incorporating the rebound cushion rubber 102 assembled together with the outer bracket 20, the pair of abutting faces 38, 38 formed on the outside peripheral face of the rebound cushion rubber 102 are positioned in alignment in the circumferential direction with the pair of abutted faces 84, 84 formed on the inside peripheral of the outer bracket 20.

The rebound cushion rubber 102 in the present embodiment is constituted such that the distance between the pair of abutting faces 38, 38 formed on the outside peripheral face at both sides thereof in the major axis direction, in other words, the diameter dimension of the rebound cushion rubber 102 in its major axis direction, is smaller than that of the rebound cushion rubber 34 discussed in the preceding first embodiment. The abutting faces 38 are disposed facing the abutted faces 84, 84 formed on the inside peripheral of the outer bracket 20, situated a prescribed distance away from them in the axis-perpendicular direction, with a gap 106 being formed between the opposed abutting faces 38 and abutted faces 84, 84. The abutting faces 38 and abutted faces 84, 84 are situated a prescribed distance apart and facing one another; in the present embodiment, the distance separating the abutting faces 38 and abutted faces 84, 84 (the dimension of the gaps 106) is designated as d.

The outside peripheral face of the rebound cushion rubber 102 on both sides thereof in the minor axis direction are constituted as elliptically curving bowed outside peripheral faces 108. As in the first embodiment described previously, the bowed outside peripheral faces 108 are spaced apart in the axis-perpendicular direction from the inside peripheral face of the small-diameter tube portion 76 of the outer bracket 20, so that the rebound cushion rubber 102 and the small-diameter tube portion 76 of the outer bracket 20 are spaced apart from one another in the minor axis direction.

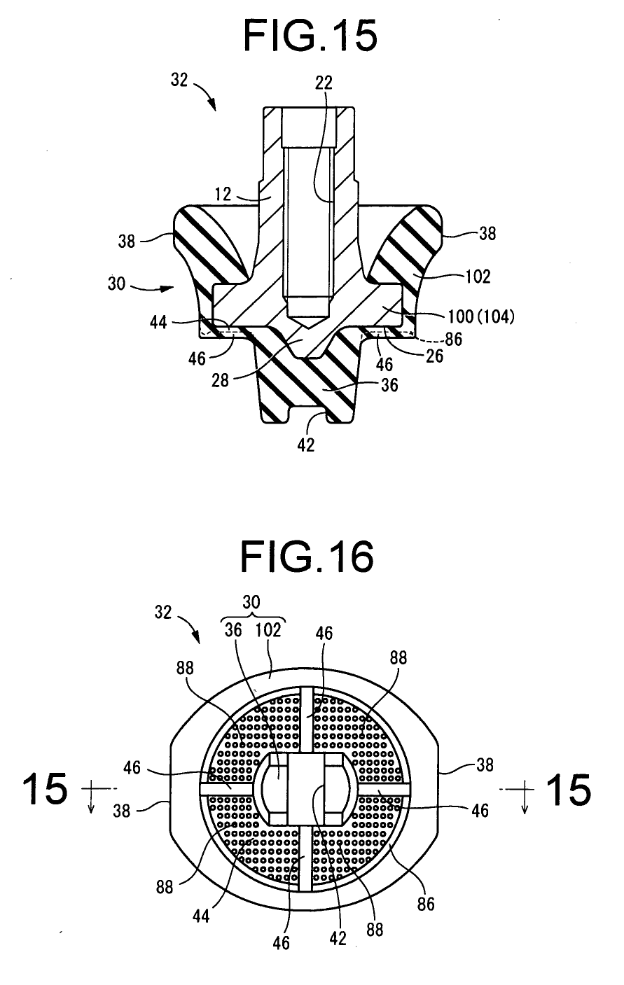

As shown in FIGS. 15 and 16, in the present embodiment, there are no pressure lips 40 formed at both circumferential edges of the abutting faces 38 as in the first embodiment described previously, so that the circumferential edges of each abutting face 38 are directly continuous with the circumferential edges of the bowed outside peripheral faces 108. Consequently, in the present embodiment, indirect contact of the rebound cushion rubber 102 with the small-diameter tube portion 76 of the outer bracket 20 via the pressure lips 40 is avoided.

By means of this arrangement, as shown in FIG. 14, the rebound cushion rubber 102 in the present embodiment is positioned diametrically inward from the small-diameter tube portion 76 of the outer bracket 20 all the way around the circumference, with the outside peripheral face of the rebound cushion rubber 102 spaced apart inwardly in the axis-perpendicular direction with respect to the small-diameter tube portion 76 of the outer bracket 20, all the way around the circumference.

In the present embodiment, as shown in FIG. 14, where the maximum radius of the rebound cushion rubber 102 (the diameter dimension at the boundary of the abutting face 38 with the bowed outside peripheral face 108) is designated as r, and the minimum radius of the outer bracket 20 (the distance from the center of the outer bracket 20 to the abutted face 84) is designated as R, r>R. Consequently, if the rebound cushion rubber 102 and the outer bracket 20 should rotate relative to one another by a prescribed amount in the circumferential direction, the boundary portion of the abutting face 38 of the rebound cushion rubber 102 with the bowed outside peripheral face 108 (i.e. the circumferential edges of the abutting faces 38) will come into abutment against the abutted face 84 of the outer bracket 20, preventing further rotation of the rebound cushion rubber 102. Specifically, a first rotation preventing mechanism for preventing relative rotation of the outer bracket 20 with respect to the first mounting member 12 is achieved by means of interference (contact) between the abutting faces 38 and the abutted faces 84, based on the two side squared-off shapes of the rebound cushion rubber 102 and the outer bracket 20.

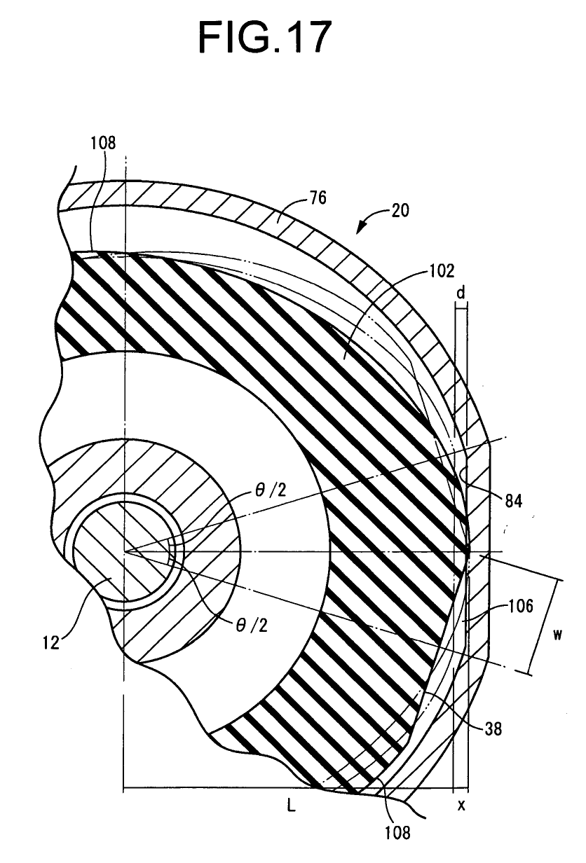

As shown in FIG. 17, such contact of the rebound cushion rubber 102 against the outer bracket 20 may be achieved by establishing values for the angle: θ of the rotation center angle of the rebound cushion rubber 102 at which the projecting length of the rebound cushion rubber 102 into the gap 106 reaches its maximum, for the distance: L from the mounting center axis to one abutting face 38, for the circumferential width dimension: 2w of the abutting face 38, and for the gap: d between the opposed abutting face 38 and abutted face 84 such that equation given below is met.
sin(θ/2)<w/(d+L) Equation 1

Thus, if the rebound cushion rubber 102 should happen to rotate by an angle equivalent to θ/2 from its prescribed attached state with respect to the outer bracket 20, the abutting face 38 will come into contact against the abutted face 84.

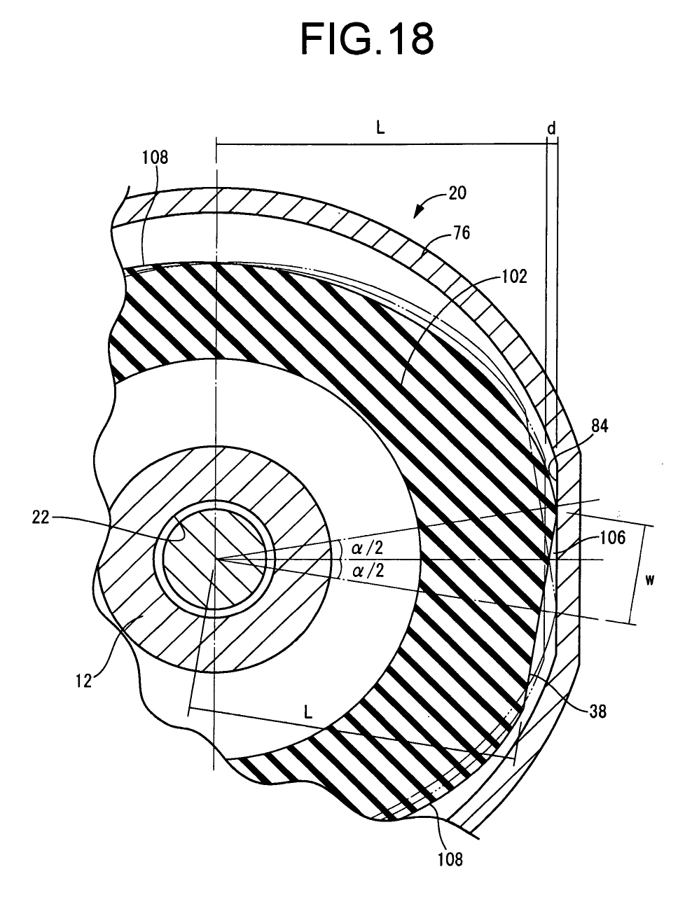

As shown in FIG. 18, where the amount of permissible relative rotation of the rebound cushion rubber 102 with respect to the outer bracket 20 is to be set to a specific rotation center angle: α. In other words, where it is intended that the abutting face 38 will come into contact against the abutted face 84 by means of the rebound cushion rubber 102 (or the outer bracket 20) rotating by the equivalent of a rotation angle: α/2 from the initial position, values for w, L, and d will be established such that the following equation is met.
[(L tan(α/2)/sin(α/2))−L]+[(w−L tan(α/2))sin(α/2)]=d Equation 2

This arrangement makes it possible to design the rebound cushion rubber 102 such that the abutting face 38 will come into contact against the abutted face 84 by means of the rebound cushion rubber 102 (or the outer bracket 20) rotating by the equivalent of a rotation angle: α/2 from the initial position. By establishing these values in consideration of elastic deformation of the rebound cushion rubber 102, which is formed from a rubber elastomer, it is possible to more effectively prevent rotation through contact, and to more accurately halt rotation of the rebound cushion rubber 102 within the prescribed range of permissible rotation.

The rotation angle: α of the rebound cushion rubber 102 from a prescribed direction can be established appropriately depending on the particular vehicle in which the engine mount 98 will be installed. The rotation angle: α will preferably be established within the range α≦10°, more preferably the range α≦5°. By establishing the rotation angle: α within this range, the first mounting member 12 and the second mounting member 14 can be positioned with a sufficient level of accuracy in the circumferential direction, effectively affording outstanding effects such as ease of installation on a vehicle, as will be discussed later.

In the present embodiment, the distance between the opposed abutting face 38 and the abutted face 84 (i.e. the size of the gap 106): d will sufficiently small, preferably such that 0.1 mm≦d≦1.5 mm, and more preferably such that 0.3 mm≦d≦1.0 mm. By establishing such a dimension for the gap 106 formed between the opposed abutting face 38 and the abutted face 84, relative rotation of the rebound cushion rubber 102 and the outer bracket 20 can be advantageously prevented.

In the automotive engine mount 98 constructed in accordance with the present embodiment, with the first mounting member 12 and the second mounting member 14 positioned in a prescribed circumferential direction, the rebound cushion rubber 102 is spaced apart from the inside peripheral face of the outer bracket 20 around the entire circumference. The rebound cushion rubber 102 is made to come into contact with the inside peripheral face of the outer bracket 20 by means of rotation of the first mounting member 12 relative to the second mounting member 14, thereby limiting relative rotation of the first mounting member 12 and the second mounting member 14. By means of this arrangement, the first mounting member 12 and the second mounting member 14 are positioned stably in the circumferential direction by means of contact of the rebound cushion rubber 102 (the abutting faces 38, 38) with the outer bracket 20 (the abutted faces 84, 84), thus effectively affording easy installation onto the vehicle, as well as improved durability of the rebound cushion rubber 102 as compared to the case where, in the initial attached state, the rebound cushion rubber 102 is pushed against the outer bracket 20 in the axis-perpendicular direction from the outset.

Additionally, by spacing the rebound cushion rubber 102 apart from the outer bracket 20 around the entire circumference, it is possible to prevent the problem of cracks forming in the rebound cushion rubber 102 in the event that the rebound cushion rubber 102 installed in a vehicle is subjected to load input in a diagonal direction or in the axis-perpendicular direction. Thus, the first mounting member 12 and the second mounting member 14 may be positioned stably in the circumferential for an extended period.

Further, the outside peripheral face of the rebound cushion rubber 102 is formed as a continuous face composed of elliptically curving bowed outside peripheral faces 108, 108 and flat abutting faces 38, 38. This makes it possible to reduce or avoid stress concentrations in the rebound cushion rubber 102 that could be caused by the rebound cushion rubber 102 being pushed in the axis-perpendicular direction against the outer bracket 20 by load input in the axis-perpendicular direction. Thus, durability of the rebound cushion rubber 102 can be improved.

Also, in the present embodiment, projecting portions 104 are formed on portions of the circumference of the abutting portion 100 furnished to the first mounting member 12. With this arrangement, the distance separating the abutting portion 100 and the abutting piece 80 in the axial direction varies along the circumferential direction, and the projecting dimension in the axial direction of the rebound cushion rubber 102 situated axially between the abutting portion 100 and the abutting piece 80 is made partly smaller in the circumferential direction. It is possible thereby to hold to a low level the permitted elastic deformation of the rebound cushion rubber 102 at the circumferential locations where the projecting portions 104 have been formed, thereby preventing rupture of the rebound cushion rubber 102 due to excessive elastic deformation, and affording further improved durability.

Additionally, the pair of projecting portions 104, 104 are formed disposed on the circumference of the abutting portion 100 so as to face one another along one axis in the diametrical direction, with the pair of projecting portions 104, 104 formed at either side in the major axis direction of the rebound cushion rubber 102 which is positioned in the sideways direction of the vehicle. This arrangement makes it possible to effectively achieve improved durability as mentioned previously, while reducing adverse effects on ride comfort that may result from forming the projecting portions 104 in order to limit the amount of deformation of the rebound cushion rubber 102. In preferred practice, the projecting portions 104 will be formed so as to extend along one axis in the diametrical direction coincident with the major axis direction at the projecting distal end of a rebound cushion rubber 102 having elliptical shape in plan view as shown in the present embodiment. However, it is not always necessary for them to be formed in the major axis direction, nor is it necessary for the pair to be formed to both sides along one axis in the diametrical direction. That is, it is sufficient for there to be formed a thick projecting portion 104 that projects axially upward from at least a portion along the circumference. As specific examples, a pair of projecting portions 104, 104 could be formed along the minor axis direction as well, or projecting portions 104, 104, 104, 104 could be formed in a cross shape so as to divided the abutting portion 100 into four equal sections in the circumferential direction.

While the present invention has been described in detail in its presently preferred embodiment, for illustrative purpose only, it is to be understood that the invention is by no means limited to the details of the illustrated embodiment, but may be otherwise embodied. It is also to be understood that the present invention may be embodied with various changes, modifications and improvements which may occur to those skilled in the art, without departing from the spirit and scope of the invention.

For example, the shape, size, construction, number, placement and so on of the seal lip 86 is not limited to that taught herein by way of example. In the preceding embodiments, the seal lip 86 is furnished to the cushion rubber layer 44 on the abutting portion 24 side of the first mounting member 12, but could instead be furnished to the cushion rubber layer 68 on the flanged portion 62 side of the pressure-receiving fitting 58, or to both of the cushion rubber layers 44, 68.

The cushion rubber layers 44, 68 disposed between the superposed faces of the abutting portion 24 of the first mounting member 12 and the flanged portion 62 of the pressure-receiving fitting 58 may be modified in design appropriately depending on the required vibration damping characteristics and noise suppressing action, and are not essential components. That is, the seal lip 86 may be disposed directly on the abutting portion 24 of the first mounting member 12, on the flanged portion 62 of the pressure-receiving fitting 58, on the small-diameter face of the main rubber elastic body 16, and so on.

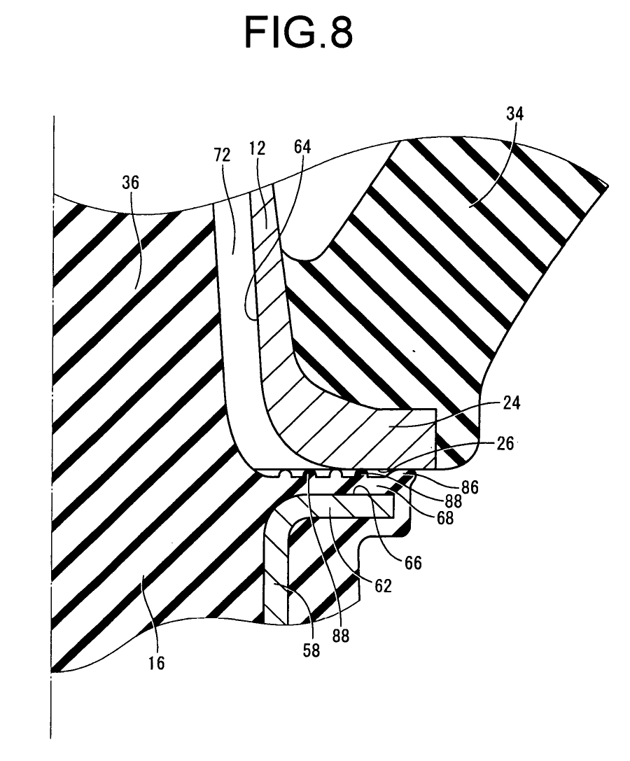

Specifically, as shown in FIG. 8 for example, the abutting portion 24 of the first mounting member 12 may be made larger in diameter than the flanged portion 62 of the pressure-receiving fitting 58 and the cushion rubber layer 68 covering the upper end face 66 of the flanged portion 62, and the seal lip 86 projected out from the outside peripheral portion of the cushion rubber layer 68. Thus, the seal lip 86 undergoes elastic deformation in direct contact against the lower end face 26 of the abutting portion 24 when the abutting portion 24 of the first mounting member 12 and the flanged portion 62 of the pressure-receiving fitting 58 are superposed.

In the preceding embodiments, the seal lip 86 is disposed extending only once around the circumference in the outside peripheral portion of the cushion rubber layer 44, but may instead be disposed in multiple segments situated spaced apart by prescribed distance in the diametrical direction. The shape, size, construction and so on of the multiple seal lip segments may be different from one another.

In the preceding embodiments, the seal lip 86 has a cross sectional shape inclined towards the outer peripheral side. However, the cross sectional shape of the seal lip may instead be inclined towards the inside peripheral side by biasing the projecting distal end portion of the seal lip towards the inside peripheral side from the lateral center portion of its basal end; or not inclined at all, by giving it a symmetrical cross sectional shape to either side of the lateral center portion of its basal end.

In the preceding embodiments, of the mating recess 64 and the bound cushion rubber 36 which make up the bound stopper mechanism, the bound cushion rubber 36 is disposed projecting from the first mounting member 12 while the mating recess 64 is furnished utilizing the inner side of the pressure-receiving fitting 58 at the small-diameter end face of the main rubber elastic body 16. However, as shown in FIG. 8 for example, the mating recess 64 could be disposed so as to open downward to the inside of the abutting portion 24 of the first mounting member 12, while the bound cushion rubber 36 is disposed projecting upward from the small-diameter end face of the main rubber elastic body 16. The bound stopper mechanism is not an essential component.

In examples shown in the preceding embodiments, with the object of adjusting spring properties in the vehicle front-back direction and vehicle sideways direction, the rebound cushion rubber 34 is of elliptical shape in plan view and is disposed abutting the outer bracket 20 in the major axis direction, while spaced apart therefrom in the minor axis direction. However, it is not always necessary for the rebound cushion rubber 34 to be of elliptical shape, and it may instead have a thick walled, generally round tubular shape, with the outside peripheral face thereof disposed abutting the inside peripheral face of the outer bracket 20 all the way around the circumference.

Also, the size, shape, construction, number, placement and other attributes of the mating recess 64, bound cushion rubber 36, air release grooves 70, and projecting ribs 46 which function as a rotation preventing mechanism for positioning the first mounting member 12 and the main rubber elastic body 16 relative to one another in the circumferential direction are not limited in any particular way, nor is the rotation preventing mechanism an essential element herein.

The pressure-receiving fitting 58 affixed to the main rubber elastic body 16 will preferably be provided for the purpose of achieving improved durability of the main rubber elastic body 16, but is not an essential element herein.

While in the preceding embodiments the outer bracket 20 is of tubular shape, it could instead be of bent plate shape as taught in U.S. Publication No. US2004/0262830 A1, for example.

In the preceding embodiments, the present invention is described in terms of a specific example of implementation in a solid type vibration damping device wherein the first mounting member 12 and the second mounting member 14 are elastically linked by the main rubber elastic body 16, it could of course be implemented in a sealed fluid type vibration damping device such as that taught in U.S. Publication No. US2004/0262830 A1, for example.

The size, shape, construction, number, placement and other attributes of the high projecting portions 90 and low projecting portions 92 pertaining to the second embodiment hereinabove are not limited to those taught herein by way of example.

The inclined portions 94 and recessed grooves 96 pertaining to the second embodiment hereinabove are not essential, and it is possible for the high projecting portions 90 and low projecting portions 92 to connect directly with one another, for example.

Additionally, the present invention is not limited to automotive engine mounts, and may be employed favorably in body mountings or differential mountings, as well as non-automotive vibration damping devices of various kinds.

What is claimed is:

1. A vibration damping device for installation between two components to be linked in a vibration damping manner, comprising:
a main rubber elastic body of frustoconical shape;
a first mounting member adapted to be fastened to one of the two components and being of independent structure, while being superposed against a small diameter end face of the rubber elastic body;
a second mounting member adapted to be fastened to an other of the two components, and being affixed to an outer circumferential face of a large-diameter end portion of the main rubber elastic body; and
a rebound stopper mechanism for cushion-wise limitation of a level of relative displacement of the first mounting member and the second mounting member in a direction of moving apart,
wherein at least one of superposed faces of the first mounting member and the rubber elastic body is provided with a seal lip at an outside peripheral portion thereof so as to project outward therefrom and extend over an entire circumference thereof.

2. A vibration damping device according to claim 1, wherein at least one of the superposed faces of the first mounting member and the main rubber elastic body is provided with grain shaped elastic projections on an inner circumferential side of the seal lip.

3. A vibration damping device according to claim 1, wherein the seal lip has a cross sectional shape inclined outside or inside over an entire circumference thereof.

4. A vibration damping device according to claim 1, wherein the seal lip is disposed at a location diametrically outside of a peripheral edge of an end face of the first mounting member superposed against the main rubber elastic body.

5. A vibration damping device according to claim 1, wherein at least one of the superposed faces of the first mounting member and the main rubber elastic body is furnished with an air venting groove opening onto the superposed face and exposed to an outer periphery of the superposed face.

6. A vibration damping device according to claim 1, wherein both of the superposed faces of the first mounting member and the main rubber elastic body have circular shape, and one of the superposed faces is larger in diameter than an other of the superposed faces, while the seal lip is formed on an outside peripheral portion of the superposed face having a smaller-diameter.

7. A vibration damping device according to claim 1, wherein the seal lip is formed projecting downward only on the superposed face positioned vertically upward in an installed state.

8. A vibration damping device according to claim 1, wherein the first mounting member includes an abutting portion spreading out in an axis-perpendicular direction at a face thereof facing the main rubber elastic body; the main rubber elastic body includes a reinforcing member spreading out in the axis-perpendicular direction on the small-diameter end thereof facing the first mounting member; the second mounting member is fixedly furnished with a rebound stopper member having a rebound stopper projecting towards the first mounting member and situated facing the abutting portion of the first mounting member while spreading outwardly with respect to the abutting portion in an axis-perpendicular direction; the first mounting member further includes a rebound cushion rubber fixed thereto, the rebound cushion rubber projecting from the abutting portion towards the rebound stopper, said abutting portion coming into abutment against said rebound stopper via said rebound cushion rubber, thereby constituting said rebound stopper mechanism; a face of the abutting portion facing the main rubber elastic body has a covering rubber layer formed by said rebound cushion rubber; the abutting portion of said first mounting member and said reinforcing member of the main rubber elastic body are superposed against each other via the covering rubber layer; and the seal lip is integrally formed on the covering rubber layer.

9. A vibration damping device according to claim 8, further comprising a bound stopper mechanism wherein at least one of opposed faces of the reinforcing member and the abutting portion of the first mounting member includes a recess in a center portion thereof, and an other one of opposed faces includes a bound cushion rubber projecting therefrom toward the recess in a center portion thereof so as to be housed within the recess so that the first mounting member and the reinforcing member come into cushioned abutment at the center portions thereof via the bound cushion rubber before coming into abutment at outside peripheral portions thereof via the covering rubber layers.

10. A vibration damping device according to claim 8, wherein the rebound cushion rubber has a projecting height varied in a circumferential direction in order to provide a high projecting portion and a low projecting portion having smaller projecting height than the high projecting portion, in alternating fashion in the circumferential direction.

11. A vibration damping device according to claim 10, wherein the rebound cushion rubber is furnished with a recessed groove opening onto a projecting distal end thereof and extending in a diametrical direction.

12. A vibration damping device according to claim 10, wherein the recessed groove is formed at both circumferential edges of said low projecting portion of the rebound cushion rubber.

13. A vibration damping device according to claim 10, wherein the abutting portion of the first mounting member is of circular disk shape; the rebound stopper member is furnished with a tubular projecting portion that extends in a round tubular shape in an axial direction from said second mounting member so as to cover said main rubber elastic body and said abutting portion from an outer peripheral side, with said rebound stopper being formed extending diametrically inward from a projecting distal end of the tubular projecting portion; a basal end portion of said rebound cushion rubber attached to said abutting portion is of round annular shape viewed in the axial direction, while a distal end portion of the rebound cushion rubber is of elliptical annular shape viewed in the axial direction; the distal end portion of said rebound cushion rubber, in areas situated in opposition across a major axis direction thereof, is disposed in abutment against an abutting piece and said tubular projecting portion of said rebound stopper, whereas in areas situated in opposition across the minor axis direction thereof is spaced apart in the diametrical direction from said tubular projecting portion of said rebound stopper so as to be disposed in abutment against said abutting piece only; and the high projecting portions are formed at respective areas situated in opposition across the major axis direction of said rebound cushion rubber, while the low projecting portions are formed at respective areas situated in opposition across the minor axis direction of said rebound cushion rubber.

14. A vibration damping device according to claim 8, wherein the rebound stopper member includes a tubular projecting portion extending in an axial direction from said second mounting member with a round tubular shape and disposed so as to cover from an outer peripheral side of the main rubber elastic body and the abutting portion, and an outside peripheral face of an distal end of the rebound cushion rubber is positioned spaced apart inwardly in the axis-perpendicular direction from an inside peripheral face of the tubular projecting portion around an entire circumference.

15. A vibration damping device according to claim 8, wherein the abutting portion of the first mounting member is of circular disk shape; and the abutting portion includes a thick portion projecting towards the rebound stopper in an axial direction formed on at least a portion of a circumference of the abutting portion so that a distance separating the abutting portion and the rebound stopper in the axial direction is smaller in localized fashion at a site where said thick portion is formed.
